(19) United States
(12) Patent Application Publication
(10) Pub. No.: US 2026/0292761 A1
(43) Pub. Date: Sep. 24, 2026

(54) ANCHOR UE DISCOVERY AND RESELECTION FOR SIDELINK COMMUNICATIONS

(71) Applicant: Intel Corporation, Santa Clara, CA (US)

(72) Inventors: Ansab Ali, Hillsboro, OR (US); Yi Guo, Shanghai (CN); Youn Hyoung Heo, Sunnyvale, CA (US); Sudeep K. Palat, Cheltenham (GB); Xiaoyan Shi, Lake Oswego, OR (US)

(21) Appl. No.: 19/161,989

(22) PCT Filed: Apr. 3, 2024
(86) PCT No.: PCT/US2024/022803

§ 371 Date: Sep. 3, 2025

Related U.S. Application Data
(60) Provisional application No. 63/493,843, filed on Apr. 3, 2023.

(51) Int. Cl. H04W 64/00; H04W 8/00; H04W 92/18

(52) U.S. Cl. CPC H04W 64/00; H04W 8/005; H04W 92/18

(57) ABSTRACT

A computer-readable storage medium stores instructions for execution by one or more processors of a UE to configure the UE as a target UE for sidelink-based positioning in a 5G NR and beyond network, and to cause the UE to perform operations. The operations include encoding a discovery announcement message for broadcasting to a plurality of anchor UEs. The discovery announcement message includes a sidelink positioning service code and sidelink positioning capabilities of the target UE. A discovery response message received from an anchor UE of the plurality of anchor UEs via a direct PCS communication link established by the anchor UE is decoded. The discovery response message indicates sidelink positioning capabilities of the anchor UE. A positioning session is initiated with the anchor UE based on the sidelink positioning capabilities of the anchor UE matching the sidelink positioning capabilities of the target UE.

### PRIORITY CLAIM

This application claims the benefit of priority to U.S. Provisional Application No. 63/493,843, filed Apr. 3, 2023, and entitled “ANCHOR USER EQUIPMENT DISCOVERY AND RESELECTION FOR SIDELINK BASED POSITIONING AND SENSING,” which application is incorporated herein by reference in its entirety.

### BACKGROUND

Mobile communications have evolved significantly from early voice systems to today's highly sophisticated integrated communication platform. With the increase in the number of different types of devices communicating with various network devices, the usage of 3GPP LTE systems has increased. The penetration of mobile devices (user equipment or UEs) in modern society has continued to drive demand for a wide variety of networked devices in many disparate environments. Fifth-generation (5G) wireless systems are forthcoming and are expected to enable even greater speed, connectivity, and usability. Next-generation 5G networks (or NR networks) and beyond (e.g., 6G networks) are expected to increase throughput, coverage, and robustness and reduce latency and operational and capital expenditures. 5G NR (and beyond) networks will continue to evolve based on 3GPP LTE-Advanced with additional potential new radio access technologies (RATs) to enrich people's lives with seamless wireless connectivity solutions, delivering fast, rich content and services. As the current cellular network frequency is saturated, higher frequencies, such as millimeter wave (mmWave) frequency, can be beneficial due to their high bandwidth.

Further enhanced operation of LTE and NR systems in the licensed as well as unlicensed spectrum is expected in future releases of 5G and beyond systems. Such enhanced operations can include techniques for configuring user equipment (UE) discovery and reselection for sidelink (SL) based positioning and sensing.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates the architecture of a network, in accordance with some aspects.

FIG. 1B and FIG. 1C illustrate a non-roaming 5G system architecture, in accordance with some aspects.

FIG. 2, FIG. 3, FIG. 4, and FIG. 5 illustrate various systems, architectures, devices, and components that may implement aspects of disclosed embodiments.

FIG. 6 illustrates an example artificial intelligence (AI)-assisted communication architecture for communication between a UE and a RAN, in accordance with some aspects.

FIG. 7 illustrates an example RAN split architecture, in accordance with some aspects.

FIG. 8 illustrates an example SL positioning architecture, in accordance with some aspects.

FIG. 9 is a swimlane diagram illustrating example functionalities for location management function (LMF)-based anchor UE selection, in accordance with some aspects.

FIG. 10 is a swimlane diagram illustrating example functionalities for LMF-assisted anchor UE selection, in accordance with some aspects.

FIG. 11 is a swimlane diagram illustrating example functionalities for configuring an ongoing SL positioning session after anchor UE reselection, in accordance with some aspects.

FIG. 12 illustrates a block diagram of a communication device such as an evolved Node-B (eNB), a new generation Node-B (gNB) (or another RAN node), an NCR, an access point (AP), a wireless station (STA), a mobile station (MS), or user equipment (UE), in accordance with some aspects.

### DETAILED DESCRIPTION

The following description and the drawings sufficiently illustrate aspects that enable those skilled in the art to practice them. Other aspects may incorporate structural, logical, electrical, process, and other changes. Portions and features of some aspects may be included in or substituted for those of other aspects. Aspects outlined in the claims encompass all available equivalents of those claims.

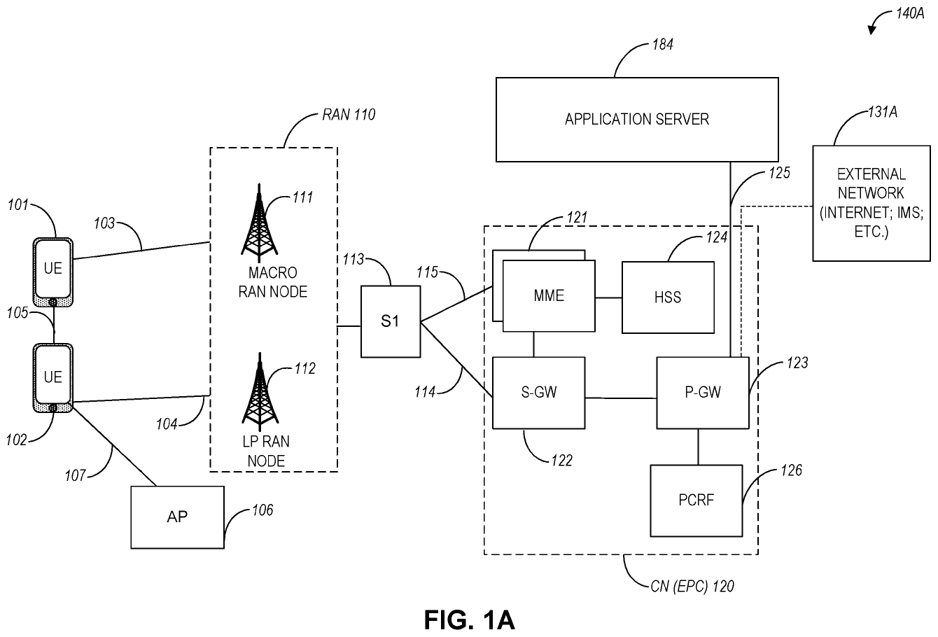

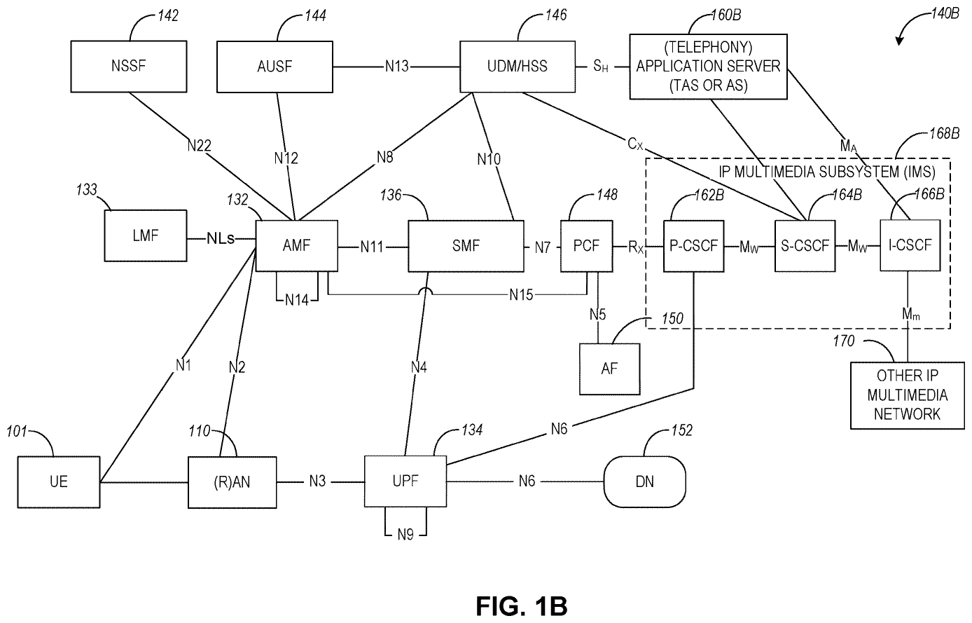

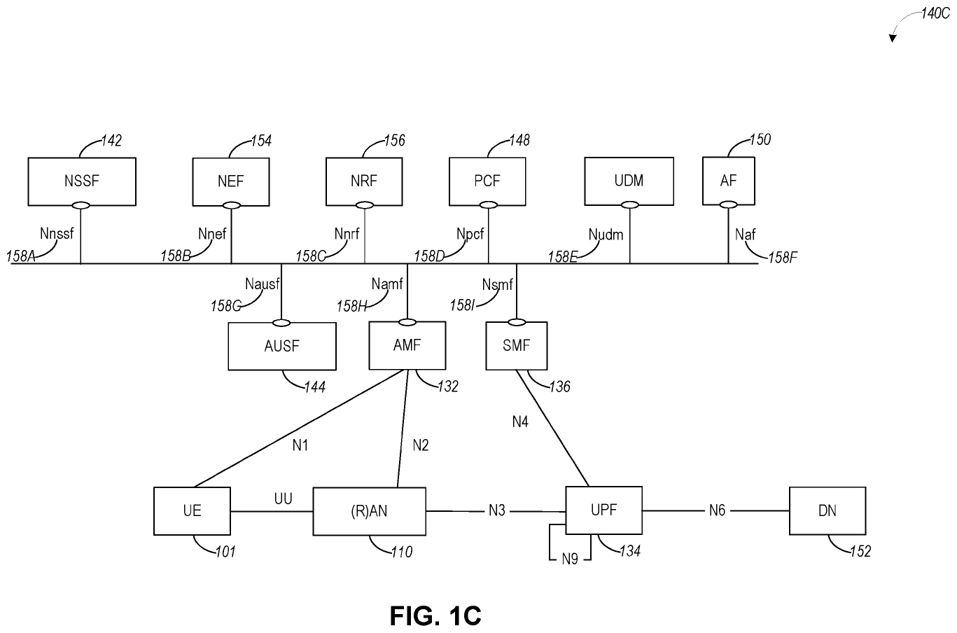

FIGS. 1A-12 illustrate various systems, devices, and components that may implement aspects of disclosed embodiments in different communication systems, such as 5G-NR (and beyond) networks. UEs, base stations (such as gNBs), and/or other nodes (e.g., satellites or other computing nodes) discussed herein can be configured to perform the disclosed techniques.

FIG. 1A illustrates the architecture of a network in accordance with some aspects. The communication network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. UE 101 and UE 102 can be collectively referred to herein as UE 101, and UE 101 can be used to perform one or more of the techniques disclosed herein.

Any of the radio links described herein (e.g., as used in the communication network 140A or any other illustrated network) may operate according to any exemplary radio communication technology and/or standard.

LTE and LTE-Advanced are standards for wireless communications of high-speed data for UE, such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme, including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHZ and further frequencies).

Aspects described herein can also be applied to different Single Carrier or OFDM flavors (CP-OFDM, SC-FDMA, SC-OFDM, filter bank-based multicarrier (FBMC), OFDMA, etc.) and, in particular, 3GPP NR (New Radio) by allocating the OFDM carrier data bit vectors to the corresponding symbol resources.

In some aspects, any of the UE 101 and UE 102 can include an Internet-of-Things (IoT) UE or a Cellular IoT (CIoT) UE, which can include a network access layer designed for low-power IoT applications utilizing short-lived UE connections. In some aspects, any of the UE 101 and UE 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure) with short-lived connections. The IoT UEs may execute background applications (e.g., keep-alive messages, status updates, etc.) to facilitate the connections of the IoT network.

In some aspects, any of the UE 101 and UE 102 can include enhanced MTC (eMTC) UEs or further enhanced MTC (FeMTC) UEs.

The UE 101 and UE 102 may be configured to connect, e.g., communicatively coupled, with a radio access network (RAN) 110. The RAN 110 may be, for example, a Universal Mobile Telecommunications System (UMTS), an Evolved Universal Terrestrial Radio Access Network (E-UTRAN), a NextGen RAN (NG RAN), or some other type of RAN. The UE 101 and UE 102 utilize connections 103 and 104, respectively, each of which includes a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can include a local wireless connection, such as, for example, a connection consistent with any IEEE 802.11 protocol, according to which the AP 106 can include a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN network nodes, and the like, and can include ground stations (e.g., terrestrial access points) or satellite stations providing coverage within a geographic area (e.g., a cell). In some aspects, communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN nodes, and one or more RAN nodes for providing femtocells or picocells (e.g., cells having smaller coverage areas, smaller user capacity, or higher bandwidth compared to macrocells), e.g., low power (LP) RAN node or an unlicensed spectrum based secondary RAN node.

Any of the communication nodes 111 and 112 can terminate the air interface protocol and can be the first point of contact for UE 101 and UE 102. In some aspects, any of the communication nodes 111 and 112 can fulfill various logical functions for the RAN 110, including, but not limited to, the radio network controller (RNC) functions such as radio bearer management, uplink, and downlink dynamic radio resource management, and data packet scheduling, and mobility management. In an example, any of the communication nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in FIGS. 1B-1C). In this aspect, the S1 interface 113 is split into two parts: the S1-U interface 114, which carries user traffic data between the communication nodes 111 and 112 and the serving gateway (S-GW) 122, and the S1-mobility management entity (MME) interface 115, which is a signaling interface between the communication nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access, such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the S1 interface 113 towards the RAN 110 and route data packets between the RAN 110 and the CN 120. In addition, the S-GW 122 may be a local mobility anchor point for inter-RAN node handovers and may also provide an anchor for inter-3GPP mobility. Other responsibilities of the S-GW 122 may include lawful intercept, charging, and some policy enforcement.

The P-GW 123 may terminate an SGi interface toward a PDN. The P-GW 123 may route data packets between the EPC network (e.g., CN 120) and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including a 5G new radio network using communications in the licensed (5G NR) and the unlicensed (5G NR-U) spectrum. One of the current enablers of IoT is the narrowband IoT (NB-IoT).

An NG system architecture can include the RAN 110 and a 5G core network (e.g., CN 120). RAN 110 in an NG system can be referred to as NG-RAN. The RAN 110 can include a plurality of nodes, such as gNBs and NG-eNBs. The CN 120 (also referred to as a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces and the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, a RAN network node, and so forth. In some aspects, a gNB can be a master node (MN), and NG-eNB can be a secondary node (SN) in a 5G architecture. In some aspects, the master/primary node may operate in a licensed band, and the secondary node may operate in an unlicensed band.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, location management function (LMF) 133, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The LMF 133 may be used in connection with 5G positioning functionalities. In some aspects, LMF 133 receives measurements and assistance information from the RAN 110 and the mobile device (e.g., UE 101) via the AMF 132 over the NLs interface to compute the position of the UE 101. In some aspects, NR positioning protocol A (NRPPa) may be used to carry the positioning information between NG-RAN and LMF 133 over a next-generation control plane interface (NG-C). In some aspects, LMF 133 configures the UE using the LTE positioning protocol (LPP) via AMF 132. The RAN 110 configures the UE 101 using radio resource control (RRC) protocol over LTE-Uu and NR-Uu interfaces.

In some aspects, the 5G system architecture 140B configures different reference signals to enable positioning measurements. Example reference signals that may be used for positioning measurements include the positioning reference signal (NR PRS) in the downlink and the sounding reference signal (SRS) for positioning in the uplink. The downlink positioning reference signal (PRS) is a reference signal configured to support downlink-based positioning methods.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IMS 168B. The S-CSCF 164B can be configured to handle the session states in the network, and the E-CSCF can be configured to handle certain aspects of emergency sessions, such as routing an emergency request to the correct emergency center or PSAP. The I-CSCF 166B can be configured to function as the contact point within an operator's network for all IMS connections destined to a subscriber of that network operator or a roaming subscriber currently located within that network operator's service area. In some aspects, the I-CSCF 166B can be connected to another IP multimedia network 170, e.g., an IMS operated by a different network operator.

In some aspects, the UDM/HSS 146 can be coupled to an application server (AS) 160B, which can include a telephony application server (TAS) or another AS. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, the 5G system architecture 140C can also include a network exposure function (NEF) 154 and a network repository function (NRF) 156. In some aspects, 5G system architectures can be service-based, and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

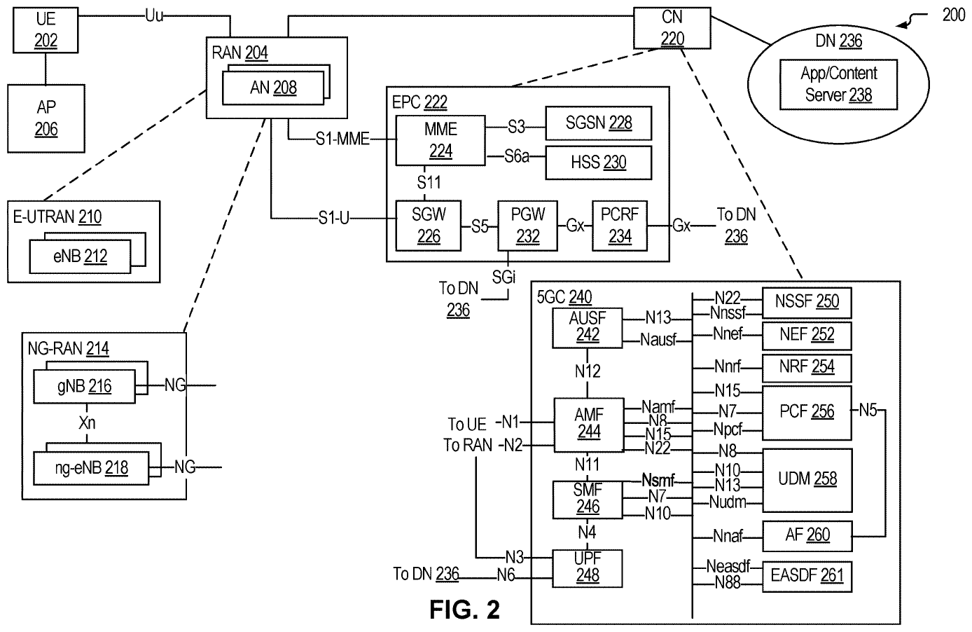

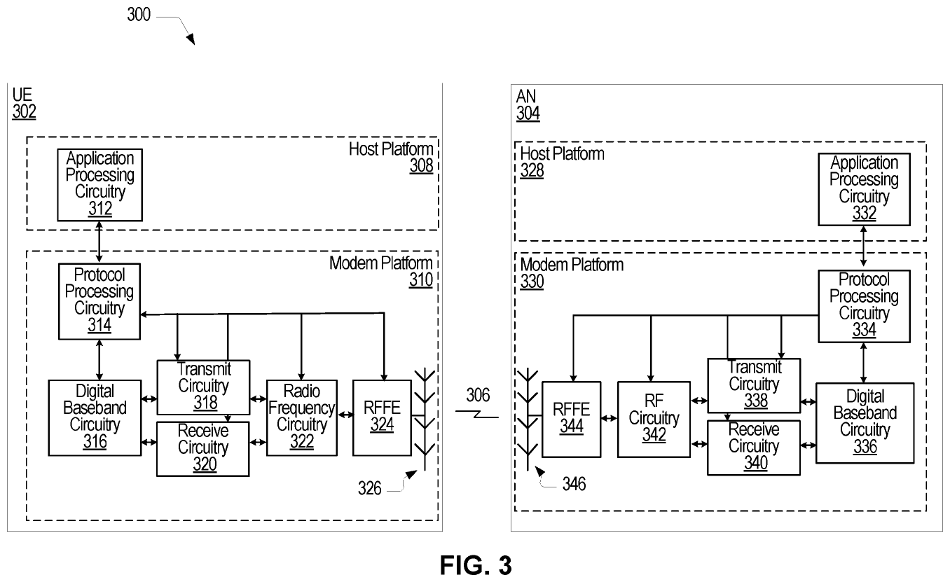

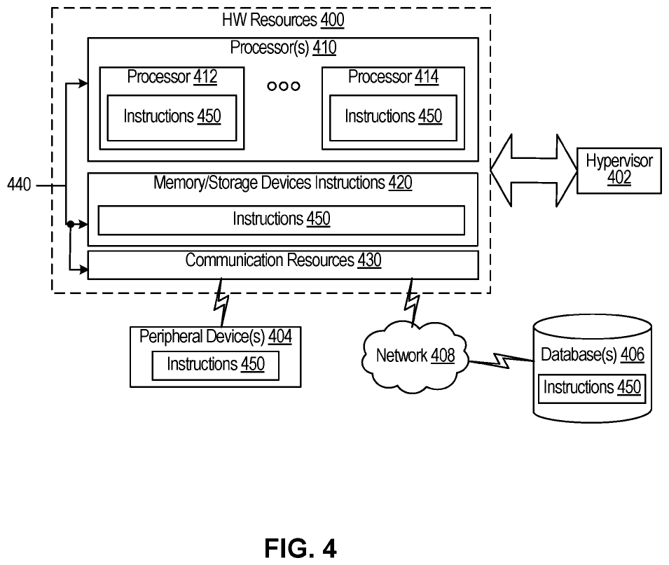

FIG. 2 depicts an example network architecture 200. The network architecture 200 may operate in a manner consistent with 3GPP technical specifications for LTE or 5G/NR systems and can implement the disclosed techniques (e.g., the disclosed techniques can be configured/implemented by one or more devices operating within the network architecture 200). However, the example embodiments are not limited in this regard, and the described examples may apply to other networks that benefit from the principles described herein, such as future 3GPP systems or the like.

The network architecture 200 includes a UE 202, which is any mobile or non-mobile computing device designed to communicate with a RAN 204 via an over-the-air connection. The UE 202 is communicatively coupled with the RAN 204 by a Uu interface, which may be applicable to both LTE and NR systems. Examples of the UE 202 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein.

Additionally or alternatively, the UE 202 can be a reduced capability (RedCap) UE, which is a UE with reduced capabilities as specified in clause 4.2.21.1 in 3GPP TS 38.306 v17.4.0 (2023-03-30) (“[TS38306]”).

The network architecture 200 may include a set of UEs 202 coupled directly with one another via a D2D, ProSe, PC5, and/or SL interface, and/or any other suitable interface such as any of those discussed herein. These UEs 202 may be M2M/D2D/MTC/IoT devices and/or vehicular systems that communicate using physical sidelink channels such as, but not limited to, PSBCH, PSDCH, PSSCH, PSCCH, PSFCH, and the like. The UE 202 may perform blind decoding attempts of SL channels/links according to the various examples herein.

In some examples, the UE 202 may additionally communicate with an AP 206 via an over-the-air (OTA) connection. The AP 206 manages a WLAN connection, which may serve to offload some/all network traffic from the RAN 204. The connection between the UE 202 and the AP 206 may be consistent with any IEEE 802.11 protocol. Additionally, the UE 202, RAN 204, and AP 206 may utilize cellular-WLAN aggregation/integration (e.g., LWA/LWIP). Cellular-WLAN aggregation may involve the UE 202 being configured by the RAN 204 to utilize both cellular radio resources and WLAN resources.

The RAN 204 includes one or more access network nodes (ANs) 208. The ANs 208 terminate air interface(s) for the UE 202 by providing access to stratum protocols, including RRC, PDCP, RLC, MAC, and PHY/L1 protocols. In this manner, the AN 208 enables data/voice connectivity between CN 220 and the UE 202. The ANs 208 may be a macrocell base station or a low-power base station for providing femtocells, picocells, or other like cells having smaller coverage areas, smaller user capacity, or higher bandwidth compared to macrocells, or some combination thereof. In these implementations, an AN 208 can be referred to as a BS, gNB, RAN node, eNB, ng-eNB, NodeB, RSU, TRxP, and the like.

One example implementation is a “CU/DU split” architecture where the ANs 208 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like) (see e.g., [TS38401]). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 208 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architecture, arrangements, and/or configurations can be used.

The set of ANs may be coupled with one another via an X2 interface (if the RAN 204 is an LTE RAN or Evolved Universal Terrestrial Radio Access Network (E-UTRAN) 210) or an Xn interface (if the RAN 204 is an NG-RAN 214). The X2/Xn interfaces, which may be separated into control/user plane interfaces in some examples, may allow the ANs to communicate information related to handovers, data/context transfers, mobility, load management, interference coordination, and the like.

The ANs of the RAN 204 may each manage one or more cells, cell groups, component carriers, and the like to provide the UE 202 with an air interface for network access. The UE 202 may be simultaneously connected with a set of cells provided by the same or different ANs 208 of the RAN 204. For example, the UE 202 and RAN 204 may use carrier aggregation to allow the UE 202 to connect with a set of component carriers, each corresponding to a Pcell or Scell. In dual connectivity scenarios, a first AN 208 may be a master node that provides an MCG, and a second AN 208 may be a secondary node that provides an SCG. The first/second ANs 208 may be any combination of eNB, gNB, ng-eNB, and the like.

The RAN 204 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

Additionally, or alternatively, individual UEs 202 provide radio information to one or more ANs 208 and/or one or more edge compute nodes (e.g., edge servers/hosts and the like). The radio information may be in the form of one or more measurement reports and may include, for example, signal strength measurements, signal quality measurements, and/or the like. Each measurement report is tagged with a timestamp and the location of the measurement (e.g., the UEs 202 current location). As examples, the measurements collected by the UEs 202 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/N0), energy per chip to interference power density ratio (Ec/I0), energy per chip to noise power density ratio (Ec/N0), peak-to-average power ratio (PAPR), reference signal received power (RSRP), Reference Signal Received Path Power (RSRPP), reference signal received quality (RSRQ), received signal strength indicator (RSSI), received channel power indicator (RCPI), received signal to noise indicator (RSNI), Received Signal Code Power (RSCP), reference signal carrier phase (RSCP), reference signal carrier phase difference (RSCPD), carrier phase positioning (CPP), Reference Signal Time Difference (RSTD), Sidelink Synchronization Signal Block (S-SSB) measurements including SSB_RP (Received (linear) average power of the resource elements that carry NR SSB signals and channels, measured at the UE antenna connector or radiated interface boundary) and/or the like, Relative Time Difference (RTD), receiver (Rx) time delay, Rx Timing Error, transmitter (Tx) time delay, Tx Timing Error, NR E-CID, Observed Time Difference Of Arrival (OTDOA), average noise plus interference (ANPI), GNSS timing of cell frames for UE positioning for E-UTRAN or 5G/NR (e.g., a timing between an AP or RAN node reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v17.0.0 (2022 Mar. 31) (“[TS 36214]”), 3GPP TS 38.215 v17.3.0 (2023 Mar. 30) (“[TS 38215]”), 3GPP TS 38.314 v17.2.0 (2023 Jan. 13) (“[TS38314]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE 80211]”), and/or the like. Additionally or alternatively, any of the measurements above (or a combination of measurements) may be collected by one or more ANs 208 and provided to the edge compute node(s).

Additionally or alternatively, the measurements can include one or more of the following measurements: measurements related to Data Radio Bearer (DRB) (e.g., number of DRBs attempted to setup, number of DRBs successfully setup, number of released active DRBs, in-session activity time for DRB, number of DRBs attempted to be resumed, number of DRBs successfully resumed, and the like); measurements related to Radio Resource Control (RRC) (e.g., mean number of RRC connections, maximum number of RRC connections, mean number of stored inactive RRC connections, maximum number of stored inactive RRC connections, number of attempted, successful, and/or failed RRC connection establishments, and the like); measurements related to UE Context (UECNTX); measurements related to Radio Resource Utilization (RRU) (e.g., DL total PRB usage, UL total PRB usage, distribution of DL total PRB usage, distribution of UL total PRB usage, DL PRB used for data traffic, UL PRB used for data traffic, DL total available PRBs, UL total available PRBs, and the like); measurements related to Registration Management (RM); measurements related to Session Management (SM) (e.g., number of PDU sessions requested to setup; number of PDU sessions successfully setup; number of PDU sessions failed to setup, and the like); measurements related to GTP Management (GTP); measurements related to IP Management (IP); measurements related to Policy Association (PA); measurements related to Mobility Management (MM) (e.g., for inter-RAT, intra-RAT, and/or Intra/Inter-frequency handovers and/or conditional handovers: number of requested, successful, and/or failed handover preparations; number of requested, successful, and/or failed handover resource allocations; number of requested, successful, and/or failed handover executions; mean and/or maximum time of requested handover executions; number of successful and/or failed handover executions per beam pair, and the like); measurements related to Virtualized Resource(s) (VR); measurements related to Carrier (CARR); measurements related to QoS Flows (QF) (e.g., number of released active QoS flows, number of QoS flows attempted to release, in-session activity time for QoS flow, in-session activity time for a UE 202, number of QoS flows attempted to setup, number of QoS flows successfully established, number of QoS flows failed to setup, number of initial QoS flows attempted to setup, number of initial QoS flows successfully established, number of initial QoS flows failed to setup, number of QoS flows attempted to modify, number of QoS flows successfully modified, number of QoS flows failed to modify, and the like); measurements related to Application Triggering (AT); measurements related to Short Message Service (SMS); measurements related to Power, Energy and Environment (PEE); measurements related to NF service (NFS); measurements related to Packet Flow Description (PFD); measurements related to Random Access Channel (RACH); measurements related to Measurement Report (MR); measurements related to Layer 1 Measurement (L1M); measurements related to Network Slice Selection (NSS); measurements related to Paging (PAG); measurements related to Non-IP Data Delivery (NIDD); measurements related to external parameter provisioning (EPP); measurements related to traffic influence (TI); measurements related to Connection Establishment (CE); measurements related to Service Parameter Provisioning (SPP); measurements related to Background Data Transfer Policy (BDTP); measurements related to Data Management (DM); and/or any other performance measurements such as those discussed in 3GPP TS 28.552 v17.3.1 (2021 Jun. 24) (“[TS 28552]”), 3GPP TS 32.425 v17.1.0 (2021 Jun. 24) (“[TS32425]”), and/or the like.

The radio information may be reported in response to a trigger event and/or on a periodic basis. Additionally or alternatively, individual UEs 202 report radio information either at a low periodicity or a high periodicity depending on a data transfer that is to take place and/or other information about the data transfer. Additionally or alternatively, the edge compute node(s) may request the measurements from the ANs 208 at low or high periodicity, or the ANs 208 may provide the measurements to the edge compute node(s) at low or high periodicity. Additionally or alternatively, the edge compute node(s) may obtain other relevant data from other edge compute node(s), core network functions (NFs), application functions (AFs), and/or other UEs 202 such as Key Performance Indicators (KPIs), with the measurement reports or separately from the measurement reports.

Additionally or alternatively, in cases where there is a discrepancy in the observation data from one or more UEs, one or more RAN nodes, and/or core network NFs (e.g., missing reports, erroneous data, and the like), simple imputations may be performed to supplement the obtained observation data such as, for example, substituting values from previous reports and/or historical data, apply an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g., the value exceeds an acceptable range/bounds or the like), such values may be dropped for the current learning/training episode or epoch. For example, on packet delivery, delay bounds may be defined or configured, and packets determined to have been received after the packet delivery delay bound may be dropped.

The UE 202 can also perform determine reference signal (RS) measurement and reporting procedures to provide the network with information about the quality of one or more wireless channels and/or the communication media in general, and this information can be used to optimize various aspects of the communication system. As examples, the measurement and reporting procedures performed by the UE 202 can include those discussed in 3GPP TS 38.211 v17.4.0 (2023 Jan. 4) (“[TS38211]”), 3GPP TS 38.212 v17.4.0 (2023 Jan. 4) (“[TS38212]”), 3GPP TS 38.213 v17.4.0 (2023 Jan. 4) (“[TS38213]”), 3GPP TS 38.214 v17.4.0 (2023 Jan. 4) (“[TS38214]”), [TS38215], 3GPP TS 38.101-1 v18.0.0 (2023 Jan. 12) (“[TS38.101-1]”), 3GPP TS 38.104 v18.0.0 (2023 Jan. 10) (“[TS38104]”), 3GPP TS 38.133 v18.0.0 (2023 Jan. 12) (“[TS38133]”), [TS38331], and/or other the like. The physical signals and/or Rscan include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), and sounding reference signal (SRS).

In any of the examples discussed herein, any suitable data collection and/or measurement mechanism(s) may be used to collect the observation data. For example, data marking (e.g., sequence numbering and the like), packet tracing, signal measurement, data sampling, and/or timestamping techniques may be used to determine any of the aforementioned metrics/observations. The collection of data may be based on the occurrence of events that trigger the collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific or may be based on various software parameters (e.g., OS type and version, and the like). Various configurations may be used to define any of the aforementioned data collection parameters. Such configurations may be defined by suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., MAMS [RFC8743]), IEEE/WiFi (e.g., [IEEE80211], [WiMAX], [IEEE16090], and the like), and/or any other like standards such as those discussed herein.

In V2X scenarios, the UE 202 or AN 208 may be or act as a roadside unit (RSU), which may refer to any transportation infrastructure entity used for V2X communications. An RSU may be implemented in or by a suitable AN or a stationary (or relatively stationary) UE. An RSU implemented in or by a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, and media, as well as applications/software to sense and control ongoing vehicular and pedestrian traffic. The RSU may provide very low latency communications required for high-speed events, such as crash avoidance, traffic warnings, and the like. Additionally or alternatively, the RSU may provide other cellular/WLAN communications services. The components of the RSU may be packaged in a weatherproof enclosure suitable for outdoor installation and may include a network interface controller to provide a wired connection (e.g., Ethernet) to a traffic signal controller or a backhaul network. Furthermore, one or more V2X RATs may be employed, which allow V2X nodes to communicate directly with one another, with infrastructure equipment (e.g., AN 208), and/or other devices/nodes. In some implementations, at least two distinct V2X RATs may be used including WLAN V2X (W-V2X) RATs based on IEEE V2X technologies (e.g., DSRC for the U.S. and ITS-G5 for Europe) and cellular V2X (C-V2X) RATs based on 3GPP V2 X technologies (e.g., LTE V2X, 5G/NR V2X, and beyond). In one example, the C-V2X RAT may utilize a C-V2X air interface, and the WLAN V2X RAT may utilize a W-V2X air interface.

The W-V2X RATs include, for example, IEEE Guide for Wireless Access in Vehicular Environments (WAVE) Architecture, IEEE Standards Association, IEEE 1609.0-2019 (10 Apr. 2019) (“[IEEE16090]”), V2X Communications Message Set Dictionary, SAE Int'l (23 Jul. 2020) (“[J2735_202007]”), Intelligent Transport Systems in the 5 GHz frequency band (ITS-G5), the [IEEE80211p] (which is the layer 1 (L1) and layer 2 (L2) part of WAVE, DSRC, and ITS-G5), and/or IEEE Standard for Air Interface for Broadband Wireless Access Systems, IEEE Std 802.16-2017, pp. 1-2726 (2 Mar. 2018) (“[WiMAX]”). The term “DSRC” refers to vehicular communications in the 5.9 GHz frequency band that is generally used in the United States, while “ITS-G 5” refers to vehicular communications in the 5.9 GHz frequency band in Europe. Since any number of different RATs are applicable (including [IEEE80211p] RATs) that may be used in any geographic or political region, the terms “DSRC” (used, among other regions, in the U.S.) and “ITS-G5” (used, among other regions, in Europe) may be used interchangeably throughout this disclosure. The access layer for the ITS-G5 interface is outlined in ETSI EN 302 663 V1.3.1 (2020 January) (hereinafter “[EN302663]”) and describes the access layer of the ITS-S reference architecture. The ITS-G5 access layer comprises [IEEE80211] (which now incorporates [IEEE80211p]), as well as features for Decentralized Congestion Control (DCC) methods discussed in ETSI TS 102 687 V1.2.1 (2018 April) (“[TS102687]”). The access layer for 3GPP LTE-V2 X based interface(s) is outlined in, inter alia, ETSI EN 303 613 V1.1.1 (2020 January), 3GPP TS 23.285 v16.2.0 (2019 December); and 3GPP 5G/NR-V2X is outlined in, inter alia, 3GPP TR 23.786 v16.1.0 (2019 June) and 3GPP TS 23.287 v18.0.0 (2023 Mar. 31) (“[TS23287]”).

In examples where the RAN 204 is an E-UTRAN 210 with one or more eNBs 212, the E-UTRAN 210 provides an LTE air interface (Uu) with the parameters and characteristics at least as discussed in 3GPP TS 36.300 v17.2.0 (2022Sep. 30) (“[TS36300]”). In examples where the RAN 204 is an next generation (NG)-RAN 214 with a set of gNBs 216. Each gNB 216 connects with 5G-enabled UEs 202 using a 5G-NR air interface (which may also be referred to as a Uu interface) with parameters and characteristics as discussed in [TS38300], among many other 3GPP standards. Where the NG-RAN 214 includes a set of ng-eNBs 218, the one or more ng-eNBs 218 connect with a UE 202 via the 5G Uu and/or LTE Uu interface. The gNBs 216 and the ng-eNBs 218 connect with the 5GC 240 through respective NG interfaces, which include an N2 interface, an N3 interface, and/or other interfaces. The gNB 216 and the ng-eNB 218 are connected over an Xn interface. Additionally, individual gNBs 216 are connected via respective Xn interfaces, and individual ng-eNBs 218 are connected via respective Xn interfaces. In some examples, the NG interface may be split into two parts, an NG user plane (NG-U) interface, which carries traffic data between the nodes of the NG-RAN 214 and a UPF 248 (e.g., N3 interface), and an NG control plane (NG-C) interface, which is a signaling interface between the nodes of the NG-RAN 214 and an AMF 244 (e.g., N2 interface).

The NG-RAN 214 may provide a 5G-NR air interface (which may also be referred to as a Uu interface) with the following characteristics: variable SCS; CP-OFDM for DL, CP-OFDM, and DFT-s-OFDM for UL; polar, repetition, simplex, and Reed-Muller codes for control and LDPC for data. The 5G-NR air interface may rely on CSI-RS, PDSCH/PDCCH DMRS, similar to the LTE air interface. The 5G-NR air interface may not use a CRS but may use PBCH DMRS for PBCH demodulation, PTRS for phase tracking for PDSCH, and tracking reference signal for time tracking. The 5G-NR air interface may operate on FR1 bands that include sub-6 GHz bands or FR2 bands that include bands from 24.25 GHz to 52.6 GHz. The 5G-NR air interface may include an SSB, which is an area of a downlink resource grid that includes PSS/SSS/PBCH.

The 5G-NR air interface may utilize BWPs for various purposes. For example, BWP can be used to adapt the SCS dynamically. For example, the UE 202 can be configured with multiple BWPs, with each BWP configuration having a different SCS. When a BWP change is indicated to the UE 202, the SCS of the transmission is changed as well. Another use case example of BWP is related to power saving. In particular, multiple BWPs can be configured for the UE 202 with different amounts of frequency resources (e.g., PRBs) to support data transmission under different traffic loading scenarios. A BWP containing a smaller number of PRBs can be used for data transmission with a small traffic load while allowing power saving at the UE 202 and, in some cases, at the gNB 216. A BWP containing a larger number of PRBs can be used for scenarios with higher traffic load.

In some implementations, individual gNBs 216 can include a gNB-CU and a set of gNB-DUs. Additionally or alternatively, gNBs 216 can include one or more RUs. In these implementations, the gNB-CU may be connected to each gNB-DU via respective F1 interfaces. In the case of network sharing with multiple cell ID broadcast(s), each cell identity associated with a subset of PLMNs corresponds to a gNB-DU, and the gNB-CU is connected to share the same physical layer of cell resources. For resiliency, a gNB-DU may be connected to multiple gNB-CUs by appropriate implementation. Additionally, a gNB-CU can be separated into gNB-CU control plane (gNB-CU-CP) and gNB-CU user plane (gNB-CU-UP) functions. The gNB-CU-CP is connected to a gNB-DU through an F1 control plane interface (F1-C), the gNB-CU-UP is connected to the gNB-DU through an F1 user plane interface (F1-U), and the gNB-CU-UP is connected to the gNB-CU-CP through an E1 interface. In some implementations, one gNB-DU is connected to only one gNB-CU-CP, and one gNB-CU-UP is connected to only one gNB-CU-CP. For resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP, and one gNB-CU-UP can be connected to multiple DUs under the control of the same gNB-CU-CP. Data forwarding between gNB-CU-UPs during intra-gNB-CU-CP handover within a gNB may be supported by Xn-U.

Similarly, individual ng-eNBs 218 can include an ng-eNB-CU and a set of ng-eNB-DUs. In these implementations, the ng-eNB-CU and each ng-eNB-DU are connected via respective W1 interfaces. An ng-eNB can include an ng-eNB-CU-CP, one or more ng-eNB-CU-UP(s), and one or more ng-eNB-DU(s). An ng-eNB-CU-CP and an ng-eNB-CU-UP are connected via the E1 interface. An ng-eNB-DU is connected to an ng-eNB-CU-CP via the W1-C interface and to an ng-eNB-CU-UP via the W1-U interface. The general principle described herein w.r.t gNB aspects also applies to ng-eNB aspects and corresponding E1 and W1 interfaces if not explicitly specified otherwise.

The node hosting user plane part of the PDCP protocol layer (e.g., gNB-CU, gNB-CU-UP, and for EN-DC, MeNB, or SgNB, depending on the bearer split) performs user inactivity monitoring. Further, it informs its inactivity or (re)activation to the node having a control plane connection towards the core network (e.g., over E1, X2, or the like). The node hosting the RLC protocol layer (e.g., gNB-DU) may perform user inactivity monitoring and further inform its inactivity or (re)activation to the node hosting the control plane (e.g., gNB-CU or gNB-CU-CP).

In these implementations, the NG-RAN 214 is layered into a Radio Network Layer (RNL) and a Transport Network Layer (TNL). The NG-RAN 214 architecture (e.g., the NG-RAN logical nodes and interfaces between them) is part of the RNL. For each NG-RAN interface (e.g., NG, Xn, F1, and the like), the related TNL protocol and the functionality are specified, for example, in [TS38401]. The TNL provides services for user plane transport and/or signaling transport. In NG-Flex configurations, each NG-RAN node is connected to all AMFs, 244 of which are AMF sets within an AMF region, supporting at least one slice, also supported by the NG-RAN node. The AMF Set and the AMF Region are defined in [TS23501].

The RAN 204 is communicatively coupled to CN 220, which includes network elements and/or network functions (NFs) to provide various functions to support data and telecommunications services to customers/subscribers (e.g., UE 202). The components of the CN 220 may be implemented in one physical node or separate physical nodes. In some examples, NFV may be utilized to virtualize any or all of the functions provided by the network elements of the CN 220 onto physical compute/storage resources in servers, switches, and the like. A logical instantiation of the CN 220 may be referred to as a network slice, and a logical instantiation of a portion of the CN 220 may be referred to as a network sub-slice.

The CN 220 may be an LTE CN 222 (also referred to as an Evolved Packet Core (EPC) 222). The EPC 222 may include MME 224, SGW 226, SGSN 228, HSS 230, PGW 232, and PCRF 234 coupled with one another over interfaces (or “reference points”) as shown. The NFs in the EPC 222 are briefly introduced as follows.

The MME 224 implements mobility management functions to track the current location of the UE 202 to facilitate paging, bearer activation/deactivation, handovers, gateway selection, authentication, and the like. The SGW 226 terminates an S1 interface toward the RAN 210 and routes data packets between the RAN 210 and the EPC 222. The SGW 226 may be a local mobility anchor point for inter-RAN node handovers and may also provide an anchor for inter-3GPP mobility. Other responsibilities may include lawful intercept, charging, and some policy enforcement. The SGSN 228 tracks the location of the UE 202 and performs security functions and access control. The SGSN 228 also performs inter-EPC node signaling for mobility between different RAT networks; PDN and S-GW selection as specified by MME 224; MME 224 selection for handovers; and the like. The S3 reference point between the MME 224 and the SGSN 228 enables user and bearer information exchange for inter-3GPP access network mobility in idle/active states. The HSS 230 includes a database for network users, including subscription-related information to support the network entities' handling of communication sessions. The HSS 230 can provide support for routing/roaming, authentication, authorization, naming/addressing resolution, location dependencies, and the like. An S6a reference point between the HSS 230 and the MME 224 may enable the transfer of subscription and authentication data for authenticating/authorizing user access to the EPC 222. The PGW 232 may terminate an SGi interface toward a data network (DN) 236 that may include an application (app)/content server 238. The PGW 232 routes data packets between the EPC 222 and the data network 236. The PGW 232 is communicatively coupled with the SGW 226 by an S5 reference point to facilitate user plane tunneling and tunnel management. The PGW 232 may further include a node for policy enforcement and charging data collection (e.g., PCEF). Additionally, the SGi reference point may communicatively couple the PGW 232 with the same or different data network 236. The PGW 232 may be communicatively coupled with a PCRF 234 via a Gx reference point. The PCRF 234 is the policy and charging control element of the EPC 222. The PCRF 234 is communicatively coupled to the app/content server 238 to determine appropriate QoS and charging parameters for service flows. The PCRF 234 also provisions associated rules into a PCEF (via Gx reference point) with appropriate TFT and QCI.

The CN 220 may be a 5GC 240, including an AUSF 242, AMF 244, SMF 246, UPF 248, NSSF 250, NEF 252, NRF 254, PCF 256, UDM 258, and AF 260 coupled with one another over various interfaces as shown. The NFs in the 5GC 240 are briefly introduced as follows.

The AUSF 242 stores data for authentication of UE 202 and handles authentication-related functionality. The AUSF 242 may facilitate a common authentication framework for various access types.

The AMF 244 allows other functions of the 5GC 240 to communicate with the UE 202 and the RAN 204 and to subscribe to notifications about mobility events with respect to the UE 202. The AMF 244 is also responsible for registration management (e.g., for registering UE 202), connection management, reachability management, mobility management, lawful interception of AMF-related events, and access authentication and authorization. The AMF 244 provides transport for SM messages between the UE 202 and the SMF 246 and acts as a transparent proxy for routing SM messages. AMF 244 also provides transport for SMS messages between UE 202 and an SMSF. AMF 244 interacts with the AUSF 242 and the UE 202 to perform various security anchor and context management functions. Furthermore, AMF 244 is a termination point of a RAN-CP interface, which includes the N2 reference point between the RAN 204 and the AMF 244. The AMF 244 is also a termination point of NAS (N1) signaling and performs NAS ciphering and integrity protection.

AMF 244 also supports NAS signaling with the UE 202 over an N3IWF interface. The N3IWF provides access to untrusted entities. N3IWF may be a termination point for the N2 interface between the (R)AN 204 and the AMF 244 for the control plane and maybe a termination point for the N3 reference point between the RAN 214 and the 248 for the user plane. As such, the AMF 244 handles N2 signaling from the SMF 246 and the AMF 244 for PDU sessions and quality of service, encapsulates/de-encapsulates packets for IPSec and N3 tunneling, marks N3 user-plane packets in the uplink, and enforces quality of service corresponding to N3 packet marking taking into account quality of service requirements associated with such marking received over N2. N3IWF may also relay UL and DL control-plane NAS signaling between the UE 202 and AMF 244 via an N1 reference point between the UE 202and the AMF 244 and relay uplink and downlink user-plane packets between the UE 202 and UPF 248. The N3IWF also provides mechanisms for IPsec tunnel establishment with the UE 202. The AMF 244 may exhibit a Namf service-based interface and maybe a termination point for an N14 reference point between two AMFs 244 and an N17 reference point between the AMF 244 and a 5G-EIR (not shown by FIG. 2).

The SMF 246 is responsible for SM (e.g., session establishment, tunnel management between UPF 248 and AN 208); UE IP address allocation and management (including optional authorization); selection and control of UP function; configuring traffic steering at UPF 248 to route traffic to proper destination; termination of interfaces toward policy control functions; controlling part of policy enforcement, charging, and quality of service; lawful intercept (for SM events and interface to LI system); termination of SM parts of NAS messages; downlink data notification; initiating AN specific SM information, sent via AMF 244 over N2 to AN 208; and determining SSC mode of a session. SM refers to the management of a PDU session, and a PDU session or “session” refers to a PDU connectivity service that provides or enables the exchange of PDUs between the UE 202 and the DN 236. The SMF 246 may also include the following functionalities to support edge computing enhancements (see, e.g., [TS23548]): selection of EASDF 261 and provision of its address to the UE as the DNS server for the PDU session; usage of EASDF 261 services as defined in [TS23548]; and for supporting the application layer architecture defined in [TS23558], provision and updates of ECS address configuration information to the UE. Discovery and selection procedures for EASDFs 261 are discussed in [TS 23501] § 6.3.23.

The UPF 248 acts as an anchor point for intra-RAT and inter-RAT mobility, an external PDU session point of interconnect to data network 236, and a branching point to support multi-homed PDU sessions. The UPF 248 also performs packet routing and forwarding, packet inspection, enforces user plane part of policy rules, lawfully intercepts packets (UP collection), performs traffic usage reporting, performs quality of service handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 248 may include an uplink classifier to support routing traffic flows to a data network.

The NSSF 250 selects a set of network slice instances serving the UE 202. The NSSF 250 also determines allowed NSSAI and the mapping to the subscribed S-NSSAIs, if needed. The NSSF 250 also determines an AMF set to be used to serve the UE 202 or a list of candidate AMFs 244 based on a suitable configuration and possibly by querying the NRF 254. The selection of a set of network slice instances for the UE 202 may be triggered by the AMF 244 with which the UE 202 is registered by interacting with the NSSF 250; this may lead to a change of AMF 244. The NSSF 250 interacts with the AMF 244 via an N22 reference point and may communicate with another NSSF in a visited network via an N31 reference point (not shown).

The NEF 252 securely exposes services and capabilities provided by 3GPP NFs for third-party, internal exposure/re-exposure, AFs 260, edge computing, or fog computing systems (e.g., edge compute node, and the like. In such examples, the NEF 252 may authenticate, authorize, or throttle the AFs.

NEF 252 may also translate information exchanged with the AF 260 and information exchanged with internal network functions. For example, the NEF 252 may translate between an AF-Service-Identifier and an internal 5GC information. NEF 252 may also receive information from other NFs based on the capabilities of other NFs that are exposed. This information may be stored at the NEF 252 as structured data or at a data storage NF using standardized interfaces. The stored information can then be re-exposed by the NEF 252 to other NFs and AFs or used for other purposes, such as analytics.

The NRF 254 supports service discovery functions, receives NF discovery requests from NF instances, and provides information on the discovered NF instances to the requesting NF instances. NRF 254 also maintains information on available NF instances and their supported services. The NRF 254 also supports service discovery functions, wherein the NRF 254 receives an NF Discovery Request from an NF instance or an SCP (not shown) and provides information about the discovered NF instances to the NF instance or SCP.

The PCF 256 provides policy rules to control plane functions and enforce them, and it may also support a unified policy framework to govern network behavior. The PCF 256 may also implement a front end to access subscription information relevant to policy decisions in a UDR of the UDM 258. In addition to communicating with functions over reference points, as shown, the PCF 256 exhibits an Npcf service-based interface.

The UDM 258 handles subscription-related information to support the network entities' handling of communication sessions and stores subscription data of UE 202. For example, subscription data may be communicated via an N8 reference point between the UDM 258 and the AMF 244. The UDM 258 may include two parts: an application front end and a UDR (e.g., UDR 259 in Figure wp). The UDR may store subscription data and policy data for the UDM 258 and the PCF 256, and/or structured data for exposure and application data (including PFDs for application detection and application request information for multiple UEs 202) for the NEF 252. The Nudr service-based interface may be exhibited by the UDR 221 to allow the UDM 258, PCF 256, and NEF 252 to access a particular set of the stored data, as well as to read, update (e.g., add, modify), delete, and subscribe to notification of relevant data changes in the UDR. The UDM 258 may include a UDM-FE, which is in charge of processing credentials, location management, subscription management, and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points, as shown, the UDM 258 may exhibit the Nudm service-based interface.

Edge Application Server Discovery Function (EASDF) 261 exhibits a Neasdf service-based interface and is connected to the SMF 246 via an N88 interface. One or multiple EASDF instances may be deployed within a PLMN, and interactions between 5GC NF(s) and the EASDF 261 take place within a PLMN. The EASDF 261 includes one or more of the following functionalities: registering to NRF 254 for EASDF 261 discovery and selection; handling the DNS messages according to the instruction from the SMF 246; and/or terminating DNS security if used. Handling the DNS messages according to the instruction from the SMF 246 includes one or more of the following functionalities: receiving DNS message handling rules and/or BaselineDNSPattern from the SMF 246; exchanging DNS messages from/with the UE 202; forwarding DNS messages to C-DNS or L-DNS for DNS query; adding EDNS client subnet (ECS) option into DNS query for an FQDN; reporting to the SMF 246 the information related to the received DNS messages; and/or buffering/discarding DNS messages from the UE 202 or DNS Server. The EASDF has direct user plane connectivity (e.g., without any NAT) with the PSA UPF over N6 for the transmission of DNS signaling exchanged with the UE. The deployment of a NAT between EASDF 261 and PSA UPF 248 may or may not be supported. Additional aspects of the EASDF 261 are discussed in [TS23548].

AF 260 provides application influence on traffic routing, provides access to NEF 252, and interacts with the policy framework for policy control. The AF 260 may influence UPF 248 (re)selection and traffic routing. Based on operator deployment, when AF 260 is considered to be a trusted entity, the network operator may permit AF 260 to interact directly with relevant NFs. In some implementations, the AF 260 is used for edge computing implementations.

The 5GC 240 may enable edge computing by selecting operator/3rd party services to be geographically close to a point that the UE 202 is attached to the network. This may reduce latency and load on the network. In edge computing implementations, the 5GC 240 may select a UPF 248 close to the UE 202 and execute traffic steering from the UPF 248 to DN 236 via the N6 interface. This may be based on the UE subscription data, UE location, and information provided by the AF 260, which allows the AF 260 to influence UPF (re)selection and traffic routing.

The data network (DN) 236 may represent various network operator services, Internet access, or third-party services that may be provided by one or more servers, including, for example, app/content server 238. The DN 236 may be an external public operator, a private PDN, or an intra-operator packet data network, for example, for the provision of IMS services. In this example, the app/content server 238 can be coupled to an IMS via an S-CSCF or the I-CSCF. In some implementations, the DN 236 may represent one or more local area DNs (LADNs), which are DNs 236 (or DN names (DNNs)) that is/are accessible by a UE 202 in one or more specific areas. Outside of these specific areas, the UE 202 is not able to access the LADN/DN 236.

Additionally, or alternatively, the DN 236 may be an edge DN 236, which is a (local) DN that supports the architecture for enabling edge applications. In these examples, the app/content server 238 may represent the physical hardware systems/devices providing app server functionality and/or the application software resident in the cloud or at an edge compute node that performs server function(s). In some examples, the app/content server 238 provides an edge hosting environment that provides the support required for the Edge Application Server's execution.

In some examples, the 5GS can use one or more edge compute nodes to provide an interface and offload processing of wireless communication traffic. In these examples, the edge compute nodes may be included in or co-located with one or more RANs 210, 214. For example, the edge compute nodes can provide a connection between the RAN 214 and UPF 248 in the 5GC 240. The edge compute nodes can use one or more NFV instances instantiated on virtualization infrastructure within the edge compute nodes to process wireless connections to and from the RAN 214 and UPF 248.

In some implementations, the edge compute nodes provide a distributed computing environment for application and service hosting and also provide storage and processing resources so that data and/or content can be processed in close proximity to subscribers (e.g., users of UEs 202) for faster response times. The edge compute nodes also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge compute nodes from the UEs 202, CN 220, DN 236, and/or server(s) (e.g., app/content server 238), or vice versa. For example, a device application or client application operating in a UE 202 may offload application tasks or workloads to one or more edge compute nodes. In another example, an edge compute node may offload application tasks or workloads to a set of UEs 202 (e.g., for distributed machine learning computation and/or the like).

The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. The edge servers are physical computer systems that may include an edge platform and/or virtualization infrastructure, and provide compute, storage, and network resources to edge computing applications. Each of the edge servers is disposed at an edge of a corresponding access network and is arranged to provide computing resources and/or various services (e.g., computational task and/or workload offloading, cloud-computing capabilities, IT services, and other like resources and/or services as discussed herein) in relatively close proximity to UEs 202. The VI of the edge compute nodes provide virtualized environments and virtualized resources for the edge hosts, and the edge computing applications may run as VMs and/or application containers on top of the VI.

In one example implementation, the ECT is and/or operates according to the MEC framework, as discussed in ETSI GR MEC 001 v3.1.1 (2022 January), ETSI GS MEC 003 v3.1.1 (2022 March), ETSI GS MEC 009 v3.1.1 (2021 June), ETSI GS MEC 010-1 v1.1.1 (2017 October), ETSI GS MEC 010-2 v2.2.1 (2022 February), ETSI GS MEC 011 v2.2.1 (2020 December), ETSI GS MEC 012 V2.2.1 (2022 February), ETSI GS MEC 013 V2.2.1 (2022 January), ETSI GS MEC 014 v2.1.1 (2021 March), ETSI GS MEC 015 v2.1.1 (2020 June), ETSI GS MEC 016 v2.2.1 (2020 April), ETSI GS MEC 021 v2.2.1 (2022 February), ETSI GR MEC 024 v2.1.1 (2019 November), ETSI GS MEC 028 V2.2.1 (2021 July), ETSI GS MEC 029 v2.2.1 (2022 January), ETSI MEC GS 030 v2.1.1 (2020 April), ETSI GR MEC 031 v2.1.1 (2020 October), U.S. Provisional App. No. 63/003,834 filed Apr. 1, 2020 (“[US'834]”), and Int'l App. No. PCT/US2020/066969 filed on Dec. 23, 2020(“[PCT'696]”) (collectively referred to herein as “[MEC]”), the contents of each of which are hereby incorporated by reference in their entireties. This example implementation (and/or in any other example implementation discussed herein) may also include NFV and/or other like virtualization technologies such as those discussed in ETSI GR NFV 001 V1.3.1 (2021 March), ETSI GS NFV 002 V1.2.1 (2014 December), ETSI GR NFV 003 V1.6.1 (2021 March), ETSI GS NFV 006 V2.1.1 (2021 January), ETSI GS NFV-INF 001 V1.1.1(2015 January), ETSI GS NFV-INF 003 V1.1.1 (2014 December), ETSI GS NFV-INF 004 V1.1.1(2015 January), ETSI GS NFV-MAN 001 v1.1.1 (2014 December), and/or Israel et al., OSM Release FIVE Technical Overview, ETSI Open Source MANO, OSM White Paper, 1st ed. (January 2019), https://osm.etsi.org/images/OSM-Whitepaper-TechContent-ReleaseFIVE-FINAL.pdf (collectively referred to as “[ETSINFV]”), the contents of each of which are hereby incorporated by reference in their entireties. Other virtualization technologies and/or service orchestration and automation platforms may be used, such as those discussed in E2E Network Slicing Architecture, GSMA, Official Doc. NG. 127, v1.0 (3 Jun. 2021), https://www.gsma.com/newsroom/wp-content/uploads//NG.127-v1.0-2.pdf, Open Network Automation Platform (ONAP) documentation, Release Istanbul, v9.0.1 (17 Feb. 2022), https://docs.onap.org/en/latest/index.html (“[ONAP]”), 3GPP Service Based Management Architecture (SBMA) as discussed in 3GPP TS 28.533 v17.1.0 (2021 Dec. 23) (“[TS28533]”), the contents of each of which are hereby incorporated by reference in their entireties.

In another example implementation, the ECT is and/or operates according to the O-RAN framework. Typically, front-end and back-end device vendors and carriers have worked closely to ensure compatibility. The flip side of such a working model is that it becomes quite difficult to plug and play with other devices, and this can hamper innovation. To combat this and to promote openness and interoperability at every level, several key players interested in the wireless domain (e.g., carriers, device manufacturers, academic institutions, and/or the like) formed the Open RAN Alliance (“O-RAN”) in 2018. The O-RAN network architecture is a building block for designing virtualized RAN on programmable hardware with radio access control powered by AI/ML. Various aspects of the O-RAN architecture are described in O-RAN Architecture Description v07.00, O-RAN Alliance WG1 (October 2022) (“[O-RAN.WG1.O-RAN-Architecture-Description]”); O-RAN Operations and Maintenance Architecture Specification v04.00, O-RAN Alliance WG1 (February 2021) (“[O-RAN.WG1.OAM-Architecture]”); O-RAN Operations and Maintenance Interface Specification v04.00, O-RAN Alliance WG1 (February 2021) (“[O-RAN.WG1.O1-Interface.0]”); O-RAN Information Model and Data Models Specification v01.00, O-RAN Alliance WG1 (February 2021); O-RAN Working Group 1 Slicing Architecture v08.00 (October 2022); O-RAN Working Group 2 (Non-RT RIC and A1 interface WG) A1 interface: Application Protocol v03.02 (July 2021); O-RAN Working Group 1 Use Cases Detailed Specification v09.00 (October 2022) (“[O-RAN.WG1.Use-Cases]”); O-RAN Working Group 2 (Non-RT RIC and A1 interface WG) A1 interface: General Aspects and Principles v03.00 (October 2022) (“[O-RAN.WG2.A1GAP]”); O-RAN Working Group 2 (Non-RT RIC and A1 interface WG) A1 interface: Type Definitions v04.00 (October 2021); O-RAN Working Group 2 (Non-RT RIC and A1 interface WG) A1 interface: Transport Protocol v02.00 (October 2022); O-RAN Working Group 2 AI/ML workflow description and requirements v01.03 O-RAN Alliance WG2 (October 2021) (“[O-RAN.WG2.AIML]”); O-RAN Working Group 2 (Non-RT RIC and A1 interface WG) Non-RT RIC Architecture v02.01 (October 2022); O-RAN Working Group 2 Non-RT RIC: Functional Architecture v01.01, O-RAN Alliance WG2 (June 2021); O-RAN Working Group 2 (Non-RT RIC and A1 interface WG): R1 interface: General Aspects and Principles v03.00, O-RAN Alliance WG2 (October 2022); O-RAN Working Group 3 Near-Real-time RAN Intelligent Controller Architecture & E2 General Aspects and Principles v02.02 (July 2022) (“[O-RAN.WG3.E2GAP]”); O-RAN Working Group 3 Near-Real-time Intelligent Controller E2 Service Model (E2SM) v02.01 (March 2022) (“[O-RAN.WG3.E2SM]”); O-RAN Working Group 3 Near-Real-time Intelligent Controller E2 Service Model (E2SM), Cell Configuration and Control v01.00 (October 2022) (“[O-RAN.WG3.E2SM-CCC]”); O-RAN Working Group 3 Near-Real-time Intelligent Controller E2 Service Model (E2SM) KPM v02.03 (October 2022) (“[O-RAN.WG3.E2SM-KPM]”); O-RAN Working Group 3 Near-Real-time Intelligent Controller E2 Service Model (E2SM) RAN Function Network Interface (NI) v01.00 (February 2020) (“[ORAN-WG3.E2SM-NI]”); O-RAN Working Group 3 Near-Real-time Intelligent Controller E2 Service Model (E2SM) RAN Control v01.03 (October 2022) (“[O-RAN.WG3.E2SM-RC]”); O-RAN Working Group 3, Near-Real-time Intelligent Controller, E2 Application Protocol (E2AP) v02.03 (October 2022) (“[O-RAN.WG3.E2AP]”); O-RAN Working Group 3 (Near-Real-time RAN Intelligent Controller and E2 Interface Working Group): Near-RT RIC Architecture v03.00 (Octobe 2022) (“[O-RAN.WG3.RICARCH]”); O-RAN Working Group 4 (Open Fronthaul Interfaces WG) Control, User and Synchronization Plane Specification v09.00 (July 2022) (“[O-RAN-WG4.CUS.0]”); O-RAN Fronthaul Working Group 4 Cooperative Transport Interface Transport Control Plane Specification v02.00, O-RAN Alliance WG4 (June 2021); O-RAN Fronthaul Working Group 4 Cooperative Transport Interface Transport Management Plane Specification v02.00 (June 2021); O-RAN Fronthaul Working Group 4 (Open Fronthaul Interfaces WG): Management Plane Specification v09.00 (July 2022) (“[O-RAN.WG4.MP.0]”); O-RAN Alliance Working Group 5 O1 Interface specification for O-CU-UP and O-CU-CP v04.00 (October 2022); O-RAN Alliance Working Group 5 O1 Interface specification for O-DU v05.00 (October 2022); O-RAN Open F1/W1/E1/X2/Xn Interfaces Working Group Transport Specification v01.00, O-RAN Alliance WG5 (April 2020); O-RAN Working Group 6 (Cloudification and Orchestration) Cloud Architecture and Deployment Scenarios for O-RAN Virtualized RAN v04.00 (October 2022) (“[O-RAN.WG6.CADS]”); O-RAN Cloud Platform Reference Designs v02.00, O-RAN Alliance WG6 (February 2021); O-RAN Working Group 6 O2 Interface General Aspects and Principles v02.00 (October 2022); O-RAN Working Group 6 (Cloudification and Orchestration Work Group); O-RAN Acceleration Abstraction Layer General Aspects and Principles v04.00 (October 2022); O-RAN Working Group 6: O-Cloud Notification API Specification for Event Consumers v03.00 (“[O-RAN.WG6.O-Cloud Notification API]”); O-RAN White Box Hardware Working Group Hardware Reference Design Specification for Indoor Pico Cell with Fronthaul Split Option 6 v02.00, O-RAN Alliance WG7 (October 2021) (“[O-RAN.WG7.IPC-HRD-Opt6]”); O-RAN WG7 Hardware Reference Design Specification for Indoor Picocell (FR1) with Split Architecture Option 7-2 v03.00, O-RAN Alliance WG7 (October 2021) (“[O-RAN.WG7.IPC-HRD-Opt7-2]”); O-RAN WG7 Hardware Reference Design Specification for Indoor Picocell (FR1) with Split Architecture Option 8 v03.00 (October 2021) (“[O-RAN.WG7.IPC-HRD-Opt8]”); O-RAN White Box Hardware Working Group Hardware Reference Design Specification for Outdoor Micro Cell with Split Architecture Option 7.2v03.00, O-RAN Alliance WG7 (October 2022) (“[O-RAN.WG7.OMC-HRD-Opt7-2]”); O-RAN White Box Hardware Working Group Hardware Reference Design Specification for Outdoor Macro Cell with Split Architecture Option 7.2 v03.00, O-RAN Alliance WG7 (July 2022) (“[O-RAN.WG7.OMAC-HRD]”); O-RAN Open X-haul Transport Working Group Management interfaces for Transport Network Elements v04.00, O-RAN Alliance WG9 (July 2022); O-RAN Open X-haul Transport Working Group Synchronization Architecture and Solution Specification v02.00, O-RAN Alliance WG9 (March 2022); O-RAN Open Xhaul Transport WG9 WDM-based Fronthaul Transport v2.0, O-RAN Alliance WG9 (March 2022); O-RAN Open Transport Working Group 9 Xhaul Packet Switched Architectures and Solutions v03.00, O-RAN Alliance WG9 (July 2022) (“[O-RAN.WG9.XPSAAS]”); O-RAN Operations and Maintenance Architecture v07.00, O-RAN Alliance WG10 (July 2022) (“[O-RAN.WG10.OAM-Architecture]”); O-RAN Operations and Maintenance Interface Specification v07.00, O-RAN Alliance WG10 (July 2022); O-RAN Operations and Maintenance Interface Specification v08.00, O-RAN Alliance WG10 (October 2022) (“[O-RAN.WG10.01-Interface.0]”); O-RAN: Towards an Open and Smart RAN, O-RAN Alliance, White Paper (October 2018); and U.S. application Ser. No. 17/484,743 filed on 24 Sep. 2021 (collectively referred to as “[O-RAN]”), the contents of each of which are hereby incorporated by reference in their entirety.

In another example implementation, the ECT is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v18.1.0 (2022 Dec. 23) (“[TS23558]”), 3GPP TS 23.501 v18.0.0 (2022 Dec. 21) (“[TS23501]”), 3GPP TS 23.548 v17.4.0 (2022 Sep. 22) (“[TS23548]”), 3GPP TR 23.700-98 v18.0.0 (2022 Dec. 23) (“[TR23700-98]”), 3GPP TS 23.222 v18.0.0 (2022 Dec. 23) (“[TS23222]”), TS 33.122 v18.0.0 (2022 Dec. 16) (“[TS33122]”), and 3GPP TS 29.222 v17.1.0 (2021 Jun. 25) (“[TS29222]”), 3GPP TS 23.502 v18.0.0 (2022 Dec. 21) (“[TS23502]”), 3GPP TS 29.522 v18.0.0 (2022 Dec. 16) (“[TS29522]”), 3GPP TS 29.122 v18.0.0 (2022 Dec. 16) (“[TS29122]”), 3GPP TS 23.682 v17.3.0 (2022 Jun. 15) (“[TS23682]”), 3GPP TS 23.434 v18.3.0 (2022 Dec. 23) (“[TS23434]”), and 3GPP TS 23.401 v18.0.0 (2022 Dec. 21) (collectively referred to as “[SA6Edge]”), the contents of each of which are hereby incorporated by reference in their entireties.

In another example implementation, the ECT is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/ (“[ISEO]”), the contents of which is hereby incorporated by reference in its entirety.

In another example implementation, the ECT operates according to the Multi-Access Management Services (MAMS) framework as discussed in Kanugovi et al., Multi-Access Management Services (MAMS), Internet Engineering Task Force (IETF), Request for Comments (RFC) 8743 (March 2020) (“[RFC8743]”), Ford et al., TCP Extensions for Multipath Operation with Multiple Addresses, IETF RFC 8684, (March 2020), De Coninck et al., Multipath Extensions for QUIC (MP-QUIC), IETF draft-deconinck-quic-multipath-07, IETA, QUIC Working Group (3 May 2021), Zhu et al., User-Plane Protocols for Multiple Access Management Service, IETF draft-zhu-intarea-mams-user-protocol-09, IETA, INTAREA (4 Mar. 2020), and Zhu et al., Generic Multi-Access (GMA) Convergence Encapsulation Protocols, IETF RFC 9188 (February 2022) (collectively referred to as “[MAMS]”), the contents of each of which are hereby incorporated by reference in their entireties.

It should be understood that the aforementioned edge computing frameworks/ECTs and services deployment examples are only illustrative examples of ECTs and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

The interfaces of the 5GC 240 include reference points and service-based interfaces. The reference points include N1 (between the UE 202 and the AMF 244), N2 (between RAN 214 and AMF 244), N3 (between RAN 214 and UPF 248), N4 (between the SMF 246 and UPF 248), N5 (between PCF 256 and AF 260), N6 (between UPF 248 and DN 236), N7 (between SMF 246 and PCF 256), N8 (between UDM 258 and AMF 244), N9 (between two UPFs 248), N10 (between the UDM 258 and the SMF 246), N11 (between the AMF 244 and the SMF 246), N12 (between AUSF 242 and AMF 244), N13 (between AUSF 242 and UDM 258), N14 (between two AMFs 244; not shown), N15 (between PCF 256 and AMF 244 in case of a non-roaming scenario, or between the PCF 256 in a visited network and AMF 244 in case of a roaming scenario), N16 (between two SMFs 246; not shown), and N22 (between AMF 244 and NSSF 250). Other reference point representations not shown in FIG. 2 can also be used. The service-based representation of FIG. 2 represents NFs within the control plane that enable other authorized NFs to access their services. The service-based interfaces (SBIs) include Namf (SBI exhibited by AMF 244), Nsmf (SBI exhibited by SMF 246), Nnef (SBI exhibited by NEF 252), Npcf (SBI exhibited by PCF 256), Nudm (SBI exhibited by the UDM 258), Naf (SBI exhibited by AF 260), Nnrf (SBI exhibited by NRF 254), Nnssf (SBI exhibited by NSSF 250), Nausf (SBI exhibited by AUSF 242). Other service-based interfaces (e.g., Nudr, N5g-eir, and Nudsf) not shown in FIG. 2 can also be used. In some examples, the NEF 252 can provide an interface to edge compute nodes, which can be used to process wireless connections with the RAN 214.

In some implementations, the network architecture 200 may include an SMSF, which is responsible for SMS subscription checking and verification, and relaying SM messages to/from the UE 202 to/from other entities, such as an SMS-GMSC/IWMSC/SMS-router. The SMS may also interact with AMF 244 and UDM 258 for a notification procedure that the UE 202 is available for SMS transfer (e.g., setting a UE not reachable flag and notifying UDM 258 when UE 202 is available for SMS).

The 5GS may also include an SCP (or individual instances of the SCP) that supports indirect communication (see, e.g., 3GPP TS 23.501 section 7.1.1); delegated discovery (see, e.g., 3GPP TS 23.501 section 7.1.1); message forwarding and routing to destination NF/NF service(s), communication security (e.g., authorization of the NF Service Consumer to access the NF Service Producer API) (see, e.g., 3GPP TS 33.501), load balancing, monitoring, overload control, and the like; and discovery and selection functionality for UDM(s) 258, AUSF(s) 242, UDR(s) 259, PCF(s) 256 with access to subscription data stored in the UDR based on UE's SUPI, SUCI or GPSI (see e.g., [TS23501] § 6.3). Load balancing, monitoring, and overload control functionality provided by the SCP may be implementation-specific. The SCP may be deployed in a distributed manner. More than one SCP can be present in the communication path between various NF Services. The SCP, although not an NF instance, can also be deployed distributed, redundant, and scalable.

FIG. 3 schematically illustrates a wireless network 300 in accordance with various embodiments. The wireless network 300 may include a UE 302 in wireless communication with AN 304. The UE 302 and AN 304 may be similar to, and substantially interchangeable with, like-named components described elsewhere herein.

The UE 302 may be communicatively coupled with the AN 304 via connection 306. Connection 306 is illustrated as an air interface to enable communicative coupling and can be consistent with cellular communications protocols such as an LTE protocol or a 5G NR protocol operating at mmWave or sub-6 GHz frequencies.

The UE 302 may include a host platform 308 coupled with a modem platform 310. The host platform 308 may include application processing circuitry 312, which may be coupled with protocol processing circuitry 314 of the modem platform 310. The application processing circuitry 312 may run various applications for the UE 302 that source/sink application data. The application processing circuitry 312 may further implement one or more layer operations to transmit/receive application data to/from a data network. These layer operations may include transport (for example, UDP) and Internet (for example, IP) operations.

The protocol processing circuitry 314 may implement one or more layer operations to facilitate the transmission or reception of data over connection 306. The layer operations implemented by the protocol processing circuitry 314 may include, for example, MAC, RLC, PDCP, RRC, and NAS operations.

The modem platform 310 may further include digital baseband circuitry 316 that may implement one or more layer operations that are “below” layer operations performed by the protocol processing circuitry 314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 310 may further include transmit circuitry 318, receive circuitry 320, RF circuitry 322, and RF front end (RFFE) 324, which may include or connect to one or more antenna panels 326. Briefly, the transmit circuitry 318 may include a digital-to-analog converter, mixer, intermediate frequency (IF) components, etc.; the receive circuitry 320 may include an analog-to-digital converter, mixer, IF components, etc.; the RF circuitry 322 may include a low-noise amplifier, a power amplifier, power tracking components, etc.; RFFE 324 may include filters (for example, surface/bulk acoustic wave filters), switches, antenna tuners, beamforming components (for example, phase-array antenna components), etc. The selection and arrangement of the components of the transmit circuitry 318, receive circuitry 320, RF circuitry 322, RFFE 324, and one or more antenna panels 326 (referred to generically as “transmit/receive components”) may be specific to details of a specific implementation such as, for example, whether the communication is TDM or FDM, in mmWave or sub-6 GHz frequencies, etc. In some embodiments, the transmit/receive components may be arranged in multiple parallel transmit/receive chains, may be disposed of in the same or different chips/modules, etc.

In some embodiments, the protocol processing circuitry 314 may include one or more instances of control circuitry (not shown) to provide control functions for the transmit/receive components.

A UE reception may be established by and via the one or more antenna panels 326, RFFE 324, RF circuitry 322, receive circuitry 320, digital baseband circuitry 316, and protocol processing circuitry 314. In some embodiments, the one or more antenna panels 326 may receive a transmission from the AN 304 by receive-beamforming signals received by a plurality of antennas/antenna elements of the one or more antenna panels 326.

A UE transmission may be established by and via the protocol processing circuitry 314, digital baseband circuitry 316, transmit circuitry 318, RF circuitry 322, RFFE 324, and one or more antenna panels 326. In some embodiments, the transmit components of the UE 302 may apply a spatial filter to the data to be transmitted to form a transmit beam emitted by the antenna elements of the one or more antenna panels 326.

Similar to the UE 302, the AN 304 may include a host platform 328 coupled with a modem platform 330. The host platform 328 may include application processing circuitry 332 coupled with protocol processing circuitry 334 of the modem platform 330. The modem platform may further include digital baseband circuitry 336, transmit circuitry 338, receive circuitry 340, RF circuitry 342, RFFE circuitry 344, and antenna panels 346. The components of the AN 304 may be similar to and substantially interchangeable with the like-named components of the UE 302. In addition to performing data transmission/reception as described above, the components of the AN 304 may perform various logical functions that include, for example, RNC functions such as radio bearer management, uplink and downlink dynamic radio resource management, and data packet scheduling.

FIG. 4 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 4 shows a diagrammatic representation of hardware resources 400, including one or more processors (or processor cores) 410, one or more memory/storage devices 420, and one or more communication resources 430, each of which may be communicatively coupled via a bus 440 or other interface circuitry. For embodiments where node virtualization (e.g., NFV) is utilized, a hypervisor 402 may be executed to provide an execution environment for one or more network slices/sub-slices to utilize the hardware resources 400.

The one or more processors 410 may include, for example, a processor 412 and a processor 414. The one or more processors 410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 420 may include a main memory, disk storage, or any suitable combination thereof. The memory/storage devices 420 may include but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The one or more communication resources 430 may include interconnection or network interface controllers, components, or other suitable devices to communicate with one or more peripheral devices 404 or one or more databases 406 or other network elements via a network 408. For example, the one or more communication resources 430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 450 may comprise software, a program, an application, an applet, an app, or other executable code for causing at least any of the one or more processors 410 to perform any one or more of the methodologies discussed herein. Instruction 450 may reside, completely or partially, within at least one of the one or more processors 410 (e.g., within the processor's cache memory), the memory/storage devices 420, or any suitable combination thereof. Furthermore, any portion of the instructions 450 may be transferred to the hardware resources 400 from any combination of one or more peripheral devices 404 or one or more databases 406. Accordingly, the memory of one or more processors 410, the memory/storage devices 420, one or more peripheral devices 404, and one or more databases 406 are examples of computer-readable and machine-readable media.

FIG. 5 illustrates another example network architecture 500. The network 500 may operate in a manner consistent with 3GPP technical specifications or technical reports for 6G systems. In some examples, the network 500 may operate concurrently with network architecture 200. For example, in some examples, network 500 may share one or more frequency or bandwidth resources with network architecture 200. As one specific example, a UE (e.g., UE 502) may be configured to operate in both network 500 and network 200. Such configuration may be based on a UE including circuitry configured for communication with frequency and bandwidth resources of both network architectures 200 and 500. In general, several elements of network 500 may share one or more characteristics with elements of network architecture 200. For the sake of brevity and clarity, such elements may not be repeated in the description of network 500.

The network 500 may include a UE 502, which may include any mobile or non-mobile computing device designed to communicate with a RAN 508 via an over-the-air connection. The UE 502 may be similar to, for example, UE 202. The UE 502 may be but is not limited to, a smartphone, tablet computer, wearable computer device, desktop computer, laptop computer, in-vehicle infotainment, in-car entertainment device, instrument cluster, a head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not explicitly shown in FIG. 5, in some examples, the network 500 may include a set of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not explicitly shown in FIG. 5, the UE 502 may be communicatively coupled with an AP such as AP 206, as described with respect to FIG. 2. Additionally, although not explicitly shown in FIG. 5, in some examples, the RAN 508 may include one or more ANs, such as AN 208, as described with respect to FIG. 2. The RAN 508 and/or the AN of the RAN 508 may be referred to as a base station (BS), a RAN node, or using some other term or name.

The UE 502 and the RAN 508 may be configured to communicate via an air interface that may be referred to as a sixth-generation (6G) air interface. The 6G air interface may include one or more features, such as communication in terahertz (THz) or sub-THz bandwidth or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 508 may allow for communication between the UE 502 and a 6G core network (CN) 510. Specifically, the RAN 508 may facilitate the transmission and reception of data between the UE 502 and the 6G CN 510. The 6G CN 510 may include various functions such as NSSF 250, NEF 252, NRF 254, PCF 256, UDM 258, AF 260, SMF 246, and AUSF 242. The 6G CN 510 may additionally include UPF 248 and DN 236, as shown in FIG. 5.

Additionally, the RAN 508 may include various additional functions that are in addition to, or alternative to, functions of a legacy cellular network such as a 4G or 5G network. Two such functions may include a Compute Control Function (Comp CF) 524 and a Compute Service Function (Comp SF) 536. The Comp CF 524 and the Comp SF 536 may be parts or functions of the Computing Service Plane. Comp CF 524 may be a control plane function that provides functionalities such as management of the Comp SF 536, computing task context generation and management (e.g., create, read, modify, delete), interaction with the underlying computing infrastructure for computing resource management, etc. Comp SF 536 may be a user plane function that serves as the gateway to interface computing service users (such as UE 502) and computing nodes behind a Comp SF instance. Some functionalities of the Comp SF 536 may include parsing computing service data received from users to compute tasks executable by computing nodes, holding service mesh ingress gateway or service API gateway, service and charging policies enforcement, performance monitoring and telemetry collection, etc. In some examples, a Comp SF 536 instance may serve as the user plane gateway for a cluster of computing nodes. A Comp CF 524 instance may control one or more Comp SF 536 instances.

Two other such functions may include a Communication Control Function (Comm CF) 528 and a Communication Service Function (Comm SF) 538, which may be parts of the Communication Service Plane. The Comm CF 528 may be the control plane function for managing the Comm SF 538, communication session creation/configuration/releasing, and managing communication session context. The Comm SF 538 may be a user plane function for data transport. Comm CF 528 and Comm SF 538 may be considered as upgrades of SMF 246 and UPF 248, which were described with respect to a 5G system in FIG. 2. The upgrades provided by the Comm CF 528 and the Comm SF 538 may enable service-aware transport. For legacy (e.g., 4G or 5G) data transport, SMF 246 and UPF 248 may still be used.

Two other such functions may include a Data Control Function (Data CF) 522 and a Data Service Function (Data SF) 532, which may be parts of the Data Service Plane. Data CF 522 may be a control plane function and provides functionalities such as Data SF 532 management, Data service creation/configuration/releasing, Data service context management, etc. Data SF 532 may be a user plane function and serve as the gateway between data service users (such as UE 502 and the various functions of the 6G CN 510) and data service endpoints behind the gateway. Specific functionalities may include parsing data service user data and forwarding it to corresponding data service endpoints, generating charging data, and reporting data service status.

Another such function may be the Service Orchestration and Chaining Function (SOCF) 520, which may discover, orchestrate, and chain up communication/computing/data services provided by functions in the network. Upon receiving service requests from users, SOCF 520 may interact with one or more of Comp CF 524, Comm CF 528, and Data CF 522 to identify Comp SF 536, Comm SF 538, and Data SF 532 instances, configure service resources, and generate the service chain, which could contain multiple Comp SF 536, Comm SF 538, and Data SF 532 instances and their associated computing endpoints. Workload processing and data movement may then be conducted within the generated service chain. The SOCF 520 may also be responsible for maintaining, updating, and releasing a created service chain.

Another such function may be the service registration function (SRF) 514, which may act as a registry for system services provided in the user plane, such as services provided by service endpoints behind Comp SF 536 and Data SF 532 gateways and services provided by the UE 502. The SRF 514 may be considered a counterpart of NRF 254, which may act as the registry for network functions.

Other such functions may include an evolved service communication proxy (eSCP) and service infrastructure control function (SICF) 526, which may provide service communication infrastructure for control plane services and user plane services. The eSCP may be related to the service communication proxy (SCP) of 5G, with the addition of user plane service communication proxy capabilities. The eSCP is therefore expressed in two parts: eCSP-C 512 and eSCP-U 534, for control plane service communication proxy and user plane service communication proxy, respectively. The SICF 526 may control and configure eCSP instances in terms of service traffic routing policies, access rules, load balancing configurations, performance monitoring, etc.

Another such function is the AMF 544. The AMF 544 may be similar to 244 but with additional functionality. Specifically, the AMF 544 may include potential functional repartition, such as moving the message forwarding functionality from the AMF 544 to the RAN 508.

Another such function is the service orchestration exposure function (SOEF) 518. The SOEF may be configured to expose service orchestration and chaining services to external users such as applications.

The UE 502 may include an additional function that is referred to as a computing client service function (comp CSF) 504. The comp CSF 504 may have both the control plane functionalities and user plane functionalities and may interact with corresponding network side functions such as SOCF 520, Comp CF 524, Comp SF 536, Data CF 522, and/or Data SF 532 for service discovery, request/response, compute task workload exchange, etc. The Comp CSF 504 may also work with network-side functions to decide on whether a computing task should be run on the UE 502, the RAN 508, and/or an element of the 6G CN 510.

The UE 502 and/or the Comp CSF 504 may include a service mesh proxy 506. The service mesh proxy 506 may act as a proxy for service-to-service communication in the user plane. Capabilities of the service mesh proxy 506 may include one or more of addressing, security, load balancing, and/or the like.

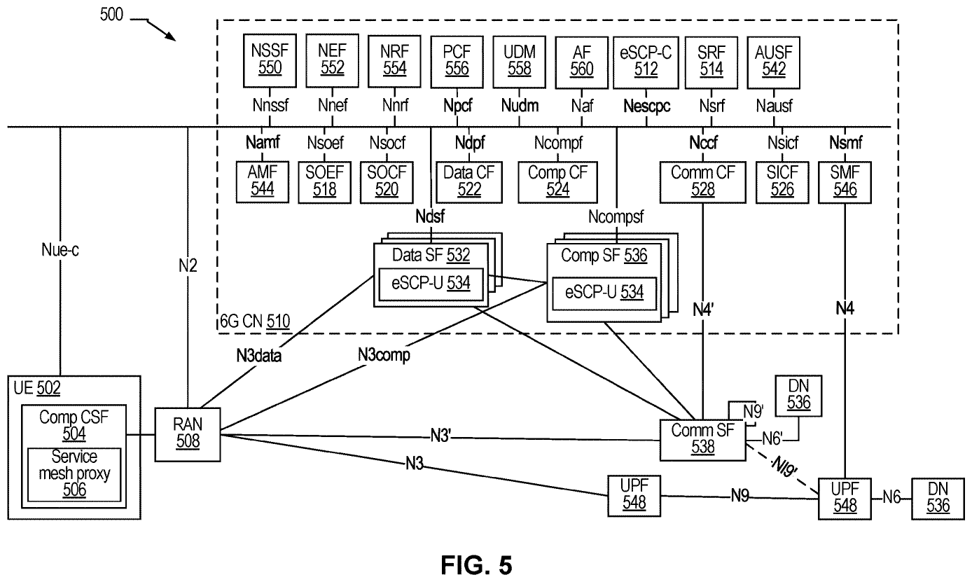

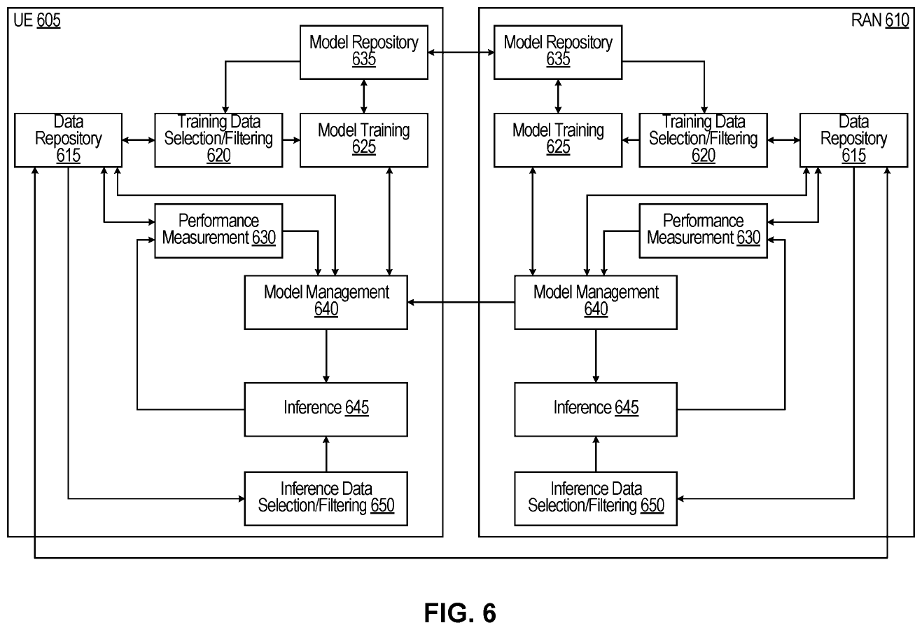

FIG. 6 depicts an example artificial intelligence (AI)-assisted communication architecture for communication between a UE 605 and a RAN 610. More specifically, as described in further detail below, AI/machine learning (ML) models may be used or leveraged to facilitate over-the-air communication between UE 605 and RAN 610.

In this example, the UE 605 and the RAN 610 operate in a manner consistent with 3GPP technical specifications and/or technical reports for 6G systems. In some examples, the wireless cellular communication between the UE 605 and the RAN 610 may be part of or operate concurrently with network architectures 500, 200, and/or some other network described herein.

The UE 605 may be similar to and share one or more features with UE 202, 202a, 202t, 2021, UE 302, UE 502, UE 702, hardware resources 400, and/or some other UE or device(s), such as any of those described herein. The UE 605 may be but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 610 may be similar to, and share one or more features with, RAN 214, RAN 508, and/or some other RAN described herein.

As may be seen in FIG. 6, the AI-related elements of UE 605 may be similar to the AI-related elements of RAN 610. For the sake of discussion herein, a description of the various elements will be provided from the point of view of the UE 605. However, it will be understood that such discussion or description will apply to equally named/numbered elements of RAN 610 unless explicitly stated otherwise.

As previously noted, the UE 605 may include various elements or functions that are related to AI/ML. Such elements may be implemented as hardware, software, firmware, and/or some combination thereof. For example, one or more of the elements may be implemented as part of the same hardware (e.g., chip or multi-processor chip), software (e.g., a computing program), or firmware as another element.

One such element may be a data repository 615. The data repository 615 may be responsible for data collection and storage. Specifically, the data repository 615 may collect and store RAN configuration parameters, measurement data, performance key performance indicators (KPIs), model performance metrics, etc., for model training, update, and inference. More generally, collected data is stored in the repository. Stored data can be discovered and extracted by other elements from the data repository 615. For example, as may be seen, the inference data selection/filter element 650 may retrieve data from the data repository 615. In various examples, the UE 605 may be configured to discover and request data from the data repository 610 in the RAN and vice versa. More generally, the data repository 615 of the UE 605 may be communicatively coupled with the data repository 615 of the RAN 610 so that the respective data repositories of the UE and the RAN may share collected data.

Another such element may be a training data selection/filtering functional block 620. The training data selection/filter functional block 620 may be configured to generate training, validation, and testing datasets for model training. Training data may be extracted from the data repository 615. Data may be selected/filtered based on the specific AI/ML model to be trained. Data may optionally be transformed/augmented/pre-processed (e.g., normalized) before being loaded into datasets. The training data selection/filter functional block 620 may label data in datasets for supervised learning. The produced datasets may then be fed into model training the model training functional block 625.

As noted above, another such element may be the model training functional block 625. This functional block may be responsible for training and updating(re-training) AI/ML models. The selected model may be trained using the fed-in datasets (including training, validation, and testing) from the training data selection/filtering functional block. The model training functional block 625 may produce trained and tested AI/ML models that are ready for deployment. The produced trained and tested models can be stored in a model repository 635.

The model repository 635 may be responsible for the storage and exposure of AI/ML models (both trained and untrained). Trained/updated model(s) may be stored in the model repository 635. Model and model parameters may be discovered and requested by other functional blocks (e.g., the training data selection/filter functional block 620 and/or the model training functional block 625). In some examples, the UE 605 may discover and request AI/ML models from the model repository 635 of the RAN 610. Similarly, the RAN 610 may be able to discover and/or request AI/ML models from the model repository 635 of the UE 605. In some examples, the RAN 610 may configure models and/or model parameters in the model repository 635 of the UE 605.

Another such element may be a model management functional block 640. The model management functional block 640 may be responsible for the management of the AI/ML model produced by the model training functional block 625. Such management functions may include the deployment of a trained model, monitoring model performance, etc. In model deployment, the model management functional block 640 may allocate and schedule hardware and/or software resources for inference based on received trained and tested models. As used herein, “inference” refers to the process of using trained AI/ML model(s) to generate data analytics, actions, policies, etc., based on input inference data. In performance monitoring, based on wireless performance KPIs and model performance metrics, the model management functional block 640 may decide to terminate the running model, start model re-training, select another model, etc. For example, the model management functional block 640 of the RAN 610 may be able to configure model management policies in the UE 605, as shown.

Another such element may be an inference data selection/filtering functional block 650. The inference data selection/filter functional block 650 may be responsible for generating datasets for model inference at the inference functional block 645, as described below. Specifically, inference data may be extracted from the data repository 615. The inference data selection/filter functional block 650 may select and/or filter the data based on the deployed AI/ML model. Data may be transformed/augmented/pre-processed following the same transformation/augmentation/pre-processing as those in training data selection/filtering as described with respect to functional block 620. The produced inference dataset may be fed into the inference functional block 645.

Another such element may be the inference functional block 645. The inference functional block 645 may be responsible for executing inference as described above. Specifically, the inference functional block 645 may consume the inference dataset provided by the inference data selection/filtering functional block 650 and generate one or more outcomes. Such outcomes may include data analytics, actions, policies, etc. The outcome(s) may be provided to the performance measurement functional block 630.

The performance measurement functional block 630 may be configured to measure model performance metrics (e.g., accuracy, model bias, run-time latency, etc.) of deployed and executing models based on the inference outcome(s) for monitoring purposes. Model performance data may be stored in the data repository 615.

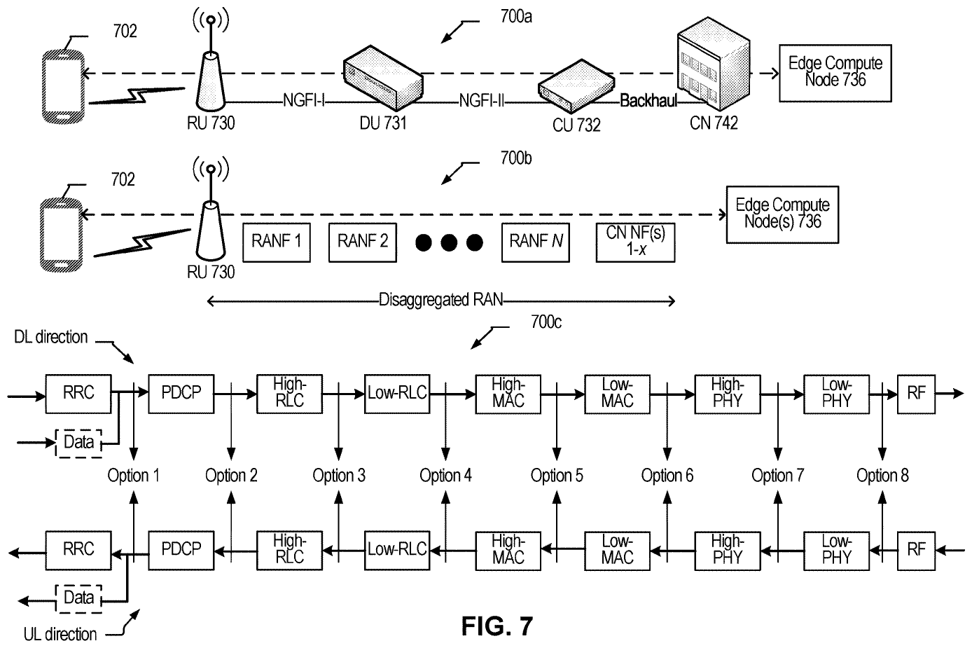

FIG. 7 depicts example RAN split architecture aspects. FIG. 7 shows an example network deployment including an example next generation fronthaul (NGF) deployment 700a where a user equipment (UE) 702 is connected to an RU 730 (also referred to as a “remote radio unit 730”, “a remote radio head 730”, or “RRH 730”) via an air interface, the RU 730 is connected to a Digital Unit (DU) 731 via a NGF interface (NGFI)-I, the DU 731 is connected to a Central Unit (CU) 732 via an NGFI-II, and the CU 732 is connected to a core network (CN) 742 via a backhaul interface. In 3GPP NG-RAN implementations (see, e.g., [TS38401]), the DU 731 may be a distributed unit (for purposes of the present disclosure, the term “DU” may refer to a digital unit and/or a distributed unit unless the context dictates otherwise). The UEs 702 may be the same or similar as the UEs 202 and/or any other UE or user/client device discussed herein.

In some implementations, the NGF deployment 700a may be arranged in a distributed RAN (D-RAN) architecture where the CU 732, DU 731, and RU 730 reside at a cell site, and the CN 742 is located at a centralized site. Alternatively, the NGF deployment 700a may be arranged in a centralized RAN (C-RAN) architecture with centralized processing of one or more baseband units (BBUs) at the centralized site. In C-RAN architectures, the radio components are split into discrete components, which can be located in different locations. In one example C-RAN implementation, only the RU 730 is disposed at the cell site, and the DU 731, the CU 732, and the CN 742 are centralized or disposed at a central location. In another example C-RAN implementation, the RU 730 and the DU 731 are located at the cell site, and the CU 732 and the CN 742 are at the centralized site. In another example of C-RAN implementation, only the RU 730 is disposed at the cell site, the DU 731 and the CU 732 are located at a RAN hub site, and the CN 742 is at the centralized site.

The CU 732 is a central controller that can serve or otherwise connect to one or multiple DUs 731 and/or multiple RUs 730. The CU 732 is a network (logical) node hosting higher/upper layers of a network protocol functional split. For example, in the 3GPP NG-RAN and/or O-RAN architectures, a CU 732 hosts the radio resource control (RRC), Service Data Adaptation Protocol (SDAP), and Packet Data Convergence Protocol (PDCP) layers of a next-generation NodeB (gNB), or hosts the RRC and PDCP protocol layers when included in or operating as an E-UTRA-NR gNB (en-gNB). The SDAP sublayer performs mapping between quality of service flows and data radio bearers (DRBs) and marking quality of service flow IDs (QFI) in both DL and UL packets. The PDCP sublayer performs transfers user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery. In various implementations, a CU 732 terminates respective Fl interfaces connected with corresponding DUs 731 (see, e.g., [TS38401]).

A CU 732 may include a CU-control plane (CP) entity (referred to herein as “CU-CP 732”) and a CU-user plane (UP) entity (referred to herein as “CU-UP 732”). The CU-CP 732 is a logical node hosting the RRC layer and the control plane part of the PDCP protocol layer of the CU 732 (e.g., a gNB-CU for an en-gNB or a gNB). The CU-CP terminates an E1 interface connected with the CU-UP, and the F1-C interface is connected with a DU 731. The CU-UP 732 is a logical node hosting the user plane part of the PDCP protocol layer (e.g., for a gNB-CU 732 of an en-gNB), and the user plane part of the PDCP protocol layer and the SDAP protocol layer (e.g., for the gNB-CU 732 of a gNB). The CU-UP 732 terminates the E1 interface connected with the CU-CP 732 and the F1-U interface connected with a DU 731.

The DU 731 controls radio resources, such as time and frequency bands, locally in real time and allocates resources to one or more UEs. The DUs 731 are network (logical) nodes hosting middle and/or lower layers of the network protocol functional split. For example, in the 3GPP NG-RAN and/or O-RAN architectures, a DU 731 hosts the radio link control (RLC) medium access control (MAC), and high-physical (PHY) layers of the gNB or en-gNB, and its operation is at least partly controlled by the CU 732. The RLC sublayer operates in one or more of a Transparent Mode (TM), Unacknowledged Mode (UM), and Acknowledged Mode (AM). The RLC sublayer performs transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; and/or protocol error detection (AM only). The MAC sublayer performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding. In some implementations, a DU 731 can host a Backhaul Adaptation Protocol (BAP) layer (see e.g., 3GPP TS 38.340 v16.5.0 (2021 Jul. 7)) and/or an F1 application protocol (F1AP) (see e.g., 3GPP TS 38.470 v16.5.0 (2021 Jul. 1)), such as when the DU 731 is operating as an Integrated Access and Backhaul (IAB) node. One DU 731 supports one or multiple cells, and one cell is supported by only one DU 731. A DU 731 terminates the F1 interface connected with a CU 732. Additionally or alternatively, the DU 731 may be connected to one or more RRHs/RUs 730.

The RU 730 is a transmission/reception point (TRP) or other physical node that handles radiofrequency (RF) processing functions. The RU 730 is a network (logical) node hosting lower layers based on a lower-layer functional split. For example, in 3GPP NG-RAN and/or O-RAN architectures, the RU 730 hosts low-PHY layer functions and RF processing of the radio interface based on a lower layer functional split. The RU 730 may be similar to 3GPP's transmission/reception point (TRP) or RRH but specifically includes the Low-PHY layer. Examples of low-PHY functions include fast Fourier transform (FFT), inverse FFT (IFFT), physical random access channel (PRACH) extraction, and the like.

Each of the CUS 732, DUs 731, and RUs 730 are connected through respective links, which may be any suitable wireless and/or wired (e.g., fiber, copper, and the like) links. In some implementations, various combinations of the CU 732, DU 731, and RU 730 may correspond to one or more of the ANs 208 of FIG. 2. Additional aspects of CUs 732, DUs 731, and RUs 730 are discussed in [O-RAN], [TS38401], [TS38410], and [TS38300], the contents of each of which are hereby incorporated by reference in their entireties.

In some implementations, a fronthaul gateway function (FHGW) may be disposed between the DU 731 and the RU/RRU 730 (not shown by FIG. 7), where the interface between the DU 731 and the FHGW is an Open Fronthaul (e.g., Option 7-2x) interface, the interface between FHGW function and the RU/RRU 730 is an Open Fronthaul (e.g., Option 7-2x) interface or any other suitable interface (e.g., option 7, option 8, or the like) including those that do not support Open Fronthaul (e.g., Option 7-2x). The FHGW may be packaged with one or more other functions (e.g., Ethernet switching and/or the like) in a physical device or appliance. In some implementations, a RAN controller may be communicatively coupled with the CU 732 and/or the DU 731.

NGFI (also referred to as “xHaul” or the like) is a two-level fronthaul architecture that separates the traditional RRU 730 to BBU connectivity in the C-RAN architecture into two levels, namely levels I and II. Level I connects the RU 730 via the NGFI-I to the DU 731, and level II connects the DU 731 via the NGFI-II to the CU 732, as shown by deployment 700a in FIG. 7. The NGFI-I and NGFI-II connections may be wired connections or wireless connections, which may utilize any suitable RAT such as any of those discussed herein. The purpose of the two-level architecture is to distribute (split) the RAN node protocol functions between CU 732 and DU 731 such that latencies are relaxed, giving more deployment flexibility. In general, the NGFI-I interfaces with the lower layers of the function split, which have stringent delay and data rate requirements. In contrast, NGFI-II interfaces with higher layers of the function split relative to the layers of the NGFI-I, relaxing the requirements for the fronthaul link. Examples of the NGFI fronthaul interfaces and functional split architectures include O-RAN 7.2x fronthaul (see e.g., [O-RAN.WG9.XPSAAS] and [O-RAN-WG4.CUS.0]), Enhanced Common Radio Interface (CPRI) based C-RAN fronthaul (see e.g., Common Public Radio Interface: eCPRI Interface Specification, eCPRI Specification v2.0 (2019 May 10), Common Public Radio Interface: Requirements for the eCPRI Transport Network, eCPRI Transport Network v1.2 (2018 Jun. 25), and [O-RAN-WG4.CUS.0]), Radio over Ethernet (RoE) based C-RAN fronthaul (see, e.g., IEEE Standard for Radio over Ethernet Encapsulations and Mappings, IEEE Standards Association, IEEE 1914.3-2018 (5 Oct. 2018) (“[IEEE1914.3]”)), and/or the like. Additional aspects of NGFI are also discussed in [O-RAN.WG9.XPSAAS], [O-RAN-WG4.CUS.0], IEEE Standard for Packet-based Fronthaul Transport Networks, IEEE Standards Association, IEEE 1914.1-2019 (21 Apr. 2020) (“[IEEE1914.1]”), [IEEE1914.3], and Nasrallah et al., Ultra-Low Latency (ULL) Networks: A Comprehensive Survey Covering the IEEE TSN Standard and Related ULL Research, arXiv:1803.07673v1 [cs.NI] (20 Mar. 2018) (“[Nasrallah]”), the contents of each of which are hereby incorporated by reference in their entirety.

In one example, the deployment 700a may implement a low-level split (LLS) (also referred to as a “Lower Layer Functional Split 7-2x” or “Split Option 7-2x”) that runs between the RU 730 (e.g., an O-RU in O-RAN architectures) and the DU 731 (e.g., an O-DU in O-RAN architectures) (see, e.g., [O-RAN.WG7.IPC-HRD-Opt7-2], [O-RAN.WG7.OMAC-HRD], [O-RAN.WG7.OMC-HRD-Opt7-2], [O-RAN.WG7.OMC-HRD-Opt7-2]). In this example implementation, the NGFI-I is the Open Fronthaul interface described in the O-RAN Open Fronthaul Specification (see, e.g., [O-RAN-WG4.CUS.0]). Other LLS options may be used, such as the relevant interfaces described in other standards or specifications such as, for example, the 3GPP NG-RAN functional split (see e.g., [TS38401] and 3GPP TR 38.801 v14.0.0 (2017 Apr. 3)), the Small Cell Forum for Split Option 6 (see e.g., 5G small cell architecture and product definitions: Configurations and Specifications for companies deploying small cells 2020-2025, Small Cell Forum, document 238.10.01 (5 Jul. 2020) (“[SCF238]”), 5G NR FR1 Reference Design: The case for a common, modular architecture for 5G NR FR1 small cell distributed radio units, Small Cell Forum, document 251.10.01 (15 Dec. 2021) (“[SCF251]”), and [O-RAN.WG7.IPC-HRD-Opt6], the contents of each of which are hereby incorporated by reference in their entireties), and/or in O-RAN white-box hardware Split Option 8 (e.g., [O-RAN.WG7.IPC-HRD-Opt8]).

Additionally or alternatively, the CUS 732, DUs 731, and/or RUs 730 may be IAB nodes. IAB enables wireless relaying in an NG-RAN where a relaying node (referred to as an “IAB-node”) supports access and backhauling via 3GPP 5G/new radio (NR) links/interfaces. The terminating node of NR backhauling on the network side is referred to as an “IAB-donor,” which represents a RAN node (e.g., a gNB) with additional functionality to support IAB. Backhauling can occur via a single or multiple hops. All IAB nodes that are connected to an IAB-donor via one or multiple hops form a directed acyclic graph (DAG) topology with the IAB-donor as its root. The IAB-donor performs centralized resource, topology, and route management for the IAB topology. The IAB architecture is shown and described in [TS38300].

Although the NGF deployment 700a shows the CU 732, DU 731, RRH 730, and CN 742 as separate entities, in other implementations, some or all of these network nodes can be bundled, combined, or otherwise integrated into a single device or element, including collapsing some internal interfaces (e.g., F1-C, F1-U, E1, E2, and the like). At least the following implementations are possible: (i) integrating the CU 732 and the DU 731 (e.g., a CU-DU), which is connected to the RRH 730 via the NGFI-I; (ii) integrating the DU 731 and the RRH 730 integrated (e.g., CU-DU), which is connected to the CU 732 via NGFI-II; (iii) integrating a RAN controller and the CU 732, which is connected to the DU 731 via NGFI-II; (iv) integrating the CU 732, the DU 731, and the RU 730, which is connected to the CN 742 via backhaul interface; and (v) integrating the network controller (or intelligent controller), the CU 732, the DU 731, and the RU 730. Any of the aforementioned example implementations involving the CU 732 may also include integrating the CU-CP 732 and CP-UP 732.

FIG. 7 also shows an example RAN disaggregation deployment 700b (also referred to as “disaggregated RAN 700b”) where the UE 702 is connected to the RRH 730, and the RRH 730 is communicatively coupled with one or more of the RAN functions (RANFs) 1-N (where N is a number). The RANFs 1-N are disaggregated and distributed geographically across several component segments and network nodes. In some implementations, each RANF 1-N is a software (SW) element operated by a physical compute node, and the RRH 730 includes radiofrequency (RF) circuitry (e.g., an RF propagation module for a particular RAT and/or the like). In this example, the RANF 1 is operated on a physical compute node that is co-located with the RRH 730, and the other RANFs are disposed at locations further away from the RRH 730. Additionally, in this example, CN 742 is also disaggregated into CN NFs 1-x (where x is a number) in the same or similar manner as the RANFs 1-N. However, in other implementations, the CN 742 is not disaggregated.

Network disaggregation (or disaggregated networking) involves the separation of networking equipment into functional components and allowing each component to be individually deployed. This may encompass the separation of SW elements (e.g., NFs) from specific HW elements and/or using APIs to enable software-defined network (SDN) and/or NF virtualization (NFV). RAN disaggregation involves network disaggregation and virtualization of various RANFs (e.g., RANFs 1-N in FIG. 7). The RANFs 1-N can be placed in different physical sites in various topologies in an RAN deployment based on the use case. This enables RANF distribution and deployment over different geographic areas and allows a breakout of RANFs to support various use cases (e.g., low latency use cases and the like) as well as flexible RAN implementations. Disaggregation offers a common or uniform RAN platform capable of assuming a distinct profile depending on where it is deployed. This allows fewer fixed-function devices and a lower total cost of ownership in comparison with existing RAN architectures. Example RAN disaggregation frameworks are provided by Telecom Infra Project (TIP) OpenRAN™, Cisco® Open vRAN™, [O-RAN], Open Optical & Packet Transport (OOPT), Reconfigurable Optical Add Drop Multiplexer (ROADM), and/or the like.

In a first example implementation, the RANFs 1-N disaggregate RAN HW and SW with commercial off-the-shelf (COTS) HW and open interfaces (e.g., NGFI-I and NGFI-II and the like). In this example implementation, each RANF 1-N may be a virtual BBU or vRAN controller operating on COTS compute infrastructure with HW acceleration for BBU/vRANFs.

In a second example implementation, the RANFs 1-N disaggregate layers of one or more RAT protocol stacks. As an example of this implementation, RANF 1 is a DU 731 operating on the first COTS compute infrastructure with HW acceleration for BBU/vRANFs, and RANF 2 is a virtual CU 732 operating on the second COTS compute infrastructure.

In a third example implementation, the RANFs 1-N disaggregate control plane and user plane functions. As an example of this implementation, the RANF 1 is a DU 731 operating on COTS compute infrastructure with HW acceleration for BBU/vRANFs, RANF 2 is a virtual CU-CP 732 operating on COTS compute infrastructure, and a third RANF (e.g., RANF 3 (not shown by FIG. 7)) is a virtual CU-UP 732 operating on the same or different COTS compute infrastructure as the virtual CU-CP 732. Additionally or alternatively, in this implementation, one or more CN NFs 1-x may be CN-UP functions, and one or more other CN NFs 1-x may be CN-CP functions.

In a fourth example implementation, the RANFs 1-N disaggregate layers of a [IEEE802] RAT. As an example of this implementation, the RRH 730 implements a WiFi PHY layer, RANF 1 implements a WiFi MAC sublayer, RANF 1 implements a WiFi logical link control (LLC) sublayer, RANF 2 implements one or more WiFi upper layer protocols (e.g., network layer, transport layer, session layer, presentation layer, and/or application layer), and so forth.

In a fifth example implementation, the RANFs 1-N disaggregate different O-RAN RANFs, including E2SMs. As an example of this implementation, RANF 1 implements the near-RT RIC, RANF 2 implements the E2SM-KPM, RANF 3 implements the E2SM-CCC, RANF 4 implements the E2SM RAN control, RANF 5 implements the E2SM-NI, RANF 6 implements functions for providing A1 services, and so forth.

In any of the implementations discussed herein, the lower layers of the RAN protocol stack can be characterized by real-time (RT) functions and relatively complex signal processing algorithms, and the higher layers of the RAN protocol stack can be characterized by non-RT functions. In these implementations, the RT functions and signal processing algorithms can be implemented in DUs 731 and/or RRHs 730 either using purpose-built network elements or in COTS hardware augmented with purpose-built HW accelerators.

FIG. 7 also shows various functional split options 700c for both DL and UL directions. The traditional RAN is an integrated network architecture based on a distributed RAN (D-RAN) model, where D-RAN integrates all RANFs into a few network elements. As alluded to previously, the disaggregated RAN architecture provides flexible function split options to overcome various drawbacks of the D-RAN model. The disaggregated RAN breaks up the integrated network system into several function components that can then be individually re-located as needed without hindering their ability to work together to provide holistic network services. The split options 700c are mostly split between the CU 732 and the DU 731 but can include a split between the CU 732, DU 731, and RU 730. For each option 700c, protocol entities on the left side of the figure are included in the RANF implementing the CU 732, and the protocol entities on the right side of the figure are included in the RANF implementing the DU 731. For example, the Option 2 function split includes splitting non-RT processing (e.g., RRC and PDCP layers) from RT processing (e.g., RLC, MAC, and PHY layers), where the RANF implementing the CU 732 performs network functions of the RRC and PDCP layers, and the RANF implementing the DU 731 performs the baseband processing functions of the RLC (including high-RLC and low-RLC), MAC (including high-MAC and low-MAC), and PHY layers. In some implementations, the PHY layer is further split between the DU 731 and the RU 730, where the RANF implementing the DU 731 performs the high-PHY layer functions, and the RU 730 handles the low-PHY layer functions. In some implementations, the Low-PHY entity may be operated by the RU 730 regardless of the selected functional split option. Under the Option 2 split, the RANF implementing the CU 732 can connect to multiple DU 731 (e.g., the CU 732 is centralized), which allows RRC and PDCP anchor change to be eliminated during a handover across DUs 731 and allows the centralized CU 732 to pool resources across several DUs 731. In these ways, the option 2 function split can improve resource efficiencies. The particular function split option used may vary depending on the service requirements and network deployment scenarios and may be implementation-specific. It should also be noted that in some implementations, all of the function split options can be selected where each protocol stack entity is operated by a respective RANF (e.g., a first RANF operates the RRC layer, a second RANF operates the PDCP layer, a third RANF operates the high-RLC layer, and so forth until an eighth RANF operates the low-PHY layer). Other split options are possible, such as those discussed in [O-RAN.WG7.IPC-HRD-Opt6], [O-RAN.WG7.IPC-HRD-Opt7-2], [O-RAN.WG7.IPC-HRD-Opt8], [O-RAN.WG7.OMAC-HRD], and [O-RAN.WG7.OMC-HRD-Opt7-2].

For one or more embodiments, at least one of the components outlined in one or more of the preceding figures may be configured to perform one or more operations, techniques, processes, and/or methods as discussed herein (including the examples listed in the examples sections below). For example, baseband circuitry associated with one or more of the preceding figures may be configured to operate in accordance with one or more of the examples set forth below. For another example, circuitry associated with a UE, base station, satellite, network element, etc., as described above in connection with one or more of the preceding figures, may be configured to operate in accordance with one or more of the examples set forth below in the example section.

The term “application” may refer to a complete and deployable package or environment to achieve a specific function in an operational environment. The term “AI/ML application” or the like may be an application that contains some artificial intelligence (AI)/machine learning (ML) models and application-level descriptions. In some embodiments, an AI/ML application may be used to configure or implement one or more of the disclosed aspects.

The term “machine learning” or “ML” refers to the use of computer systems implementing algorithms and/or statistical models to perform a specific task(s) without using explicit instructions but instead relying on patterns and inferences. ML algorithms build or estimate mathematical model(s) (referred to as “ML models” or the like) based on sample data (referred to as “training data,” “model training information,” or the like) to make predictions or decisions without being explicitly programmed to perform such tasks. Generally, an ML algorithm is a computer program that learns from experience concerning some task and some performance measure, and an ML model may be any object or data structure created after an ML algorithm is trained with one or more training datasets. After training, an ML model may be used to make predictions on new datasets. Although the term “ML algorithm” refers to concepts different from the term “ML model,” these terms, as discussed herein, may be used interchangeably for the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.), unsupervised learning (e.g., K-means clustering, principal component analysis (PCA), etc.), reinforcement learning (e.g., Q-learning, multi-armed bandit learning, deep RL, etc.), neural networks, and the like. Depending on the implementation, a specific ML model could have many sub-models as components, and the ML model may train all sub-models together. Separately trained ML models can also be chained together in an ML pipeline during inference. An “ML pipeline” is a set of functionalities, functions, or functional entities specific to an ML-assisted solution; an ML pipeline may include one or several data sources in a data pipeline, a model training pipeline, a model evaluation pipeline, and an actor. The “actor” is an entity that hosts an ML-assisted solution using the output of the ML model inference). The term “ML training host” refers to an entity, such as a network function, that hosts the training of the model. The term “ML inference host” refers to an entity, such as a network function, that hosts the model during inference mode (which includes both the model execution and any online learning, if applicable). The ML host informs the actor about the output of the ML algorithm, and the actor decides on an action (an “action” is performed by an actor as a result of the output of an ML-assisted solution). The term “model inference information” refers to information used as an input to the ML model for determining inference(s); the data used to train an ML model and the data used to determine inferences may overlap, however, “training data” and “inference data” refer to different concepts.

The present disclosure defines or otherwise provides UE behaviors and capabilities to support positioning reference signal (PRS)-based measurements such as carrier phase positioning (CPP) measurements. The following discussion may be applicable to any type of UE, such as any of the UEs in FIGS. 1A-7.

In order to support advanced positioning use cases under study for 3GPP NR Rel-18, there is a need to develop a framework to allow leveraging of NR sidelink protocol in order to perform positioning measurements. To this end, the disclosed techniques include an overall discovery process of anchor nodes that enable sideline-based positioning/sensing, which provide different approaches where the anchor UE selection can be enhanced and specify different mechanisms for reselection of anchor UEs during an ongoing SL positioning/sensing session. In this regard, the disclosed techniques include enhancements to the discovery procedure for anchor nodes to improve anchor UE selection as part of the sidelink positioning session, detail and contrast the signaling mechanisms for LMF-based and LMF-assisted anchor UE selection, and specify triggering conditions for anchor UE reselection during an ongoing positioning session and impact on the overall procedure.

With the advancement in wireless communication technology, there is an increasing demand for more precise location information. In the past, coarse location data was deemed sufficient for most applications, but now, there is a need for precise and accurate real-time location information. In the Rel-16 work in 3GPP, improvements were made to the positioning procedure using methods like higher bandwidth and multiple antennas to reduce latency and provide flexibility. As we move towards 6G, there is an even greater need for precise location information due to emerging use cases such as ranging (e.g., as described in 3GPP TS 22.261) and eV2X/Public Safety (e.g., as described in TS 22.186). In order to serve such evolving use cases, sidelink-based positioning can be leveraged, offering some unique advantages over legacy positioning and being especially suited to support different advanced V2X scenarios (such as vehicle platooning, advanced driving, and remote driving).

The overall sidelink positioning architecture and the positioning procedure can include an aspect that is uniquely different from the legacy Uu-based positioning procedure. Such an aspect is the role of the so-called anchor node and the associated functionality in the overall procedure.

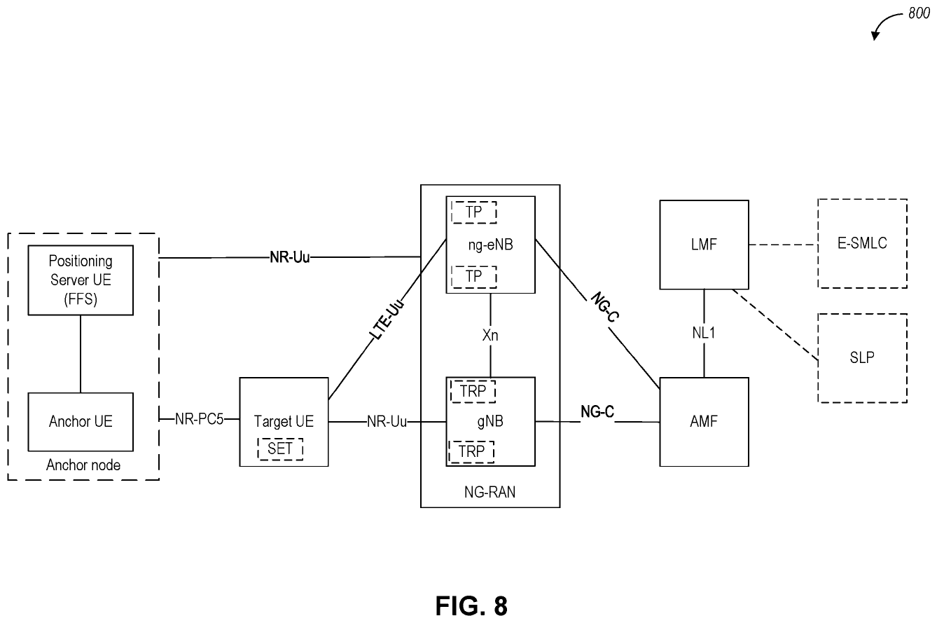

FIG. 8 illustrates an example SL positioning architecture 800, in accordance with some aspects. FIG. 8 shows a sidelink positioning architecture including the anchor UE which offers functionality that is partly based on the Location Management Function (LMF) in the legacy operation. In some aspects, the anchor node may perform at least the following functionality:
(a) It may interact with a target UE (using a new interface or the existing PC5 interface) to exchange sidelink positioning capability and assistance data (including SL-PRS configuration) for a particular location service.
(b) It may also interact with the target UE by performing sidelink positioning reference signal (SL-PRS) transmission and requesting the target UE to perform measurements, etc.
(c) If configured, it may also obtain a location estimate based on the positioning measurements provided by the target UE if requested.
(d) In addition, it may also interact with NG-RAN node(s) (using PC5 or a newly defined interface) to provide assistance data to be broadcasted. It may also interact with the LMF residing in the core network (CN) to perform the above functionalities.

In some aspects, the overall procedure for PC5-based positioning can include the following steps:
(a) Triggering event;
(b) Sidelink positioning capability exchange;
(c) Sidelink positioning assistance data transfer;
(d) SL Positioning Request Location Information;
(e) Measurement of SL-PRS;
(f) Location calculation; and
(g) SL Positioning Provide Location Information.

Compared to the legacy Uu-based positioning procedure, the general steps are similar. However, since the sidelink positioning procedure now involves one or more anchor UE/node(s), there is an additional aspect to consider, i.e., how the target UE becomes aware of and selects the anchor UE for a given positioning session. This question is the focus of the present disclosure, and in the following discussion, different methods for the discovery and selection of anchor UE(s) and their impact on the overall procedure are disclosed. While the following discussion is mostly focused on sidelink positioning, the same principles can be extended to the case of sidelink-based sensing as well.

In some aspects, at the beginning of the sidelink positioning session, i.e., when the location request is triggered (either by the UE or the LMF/AMF), the target UE may need to identify a suitable anchor UE to initiate the sidelink positioning procedure. To this end, the following approaches may be considered.

Regarding the first approach, the target UE may perform a discovery procedure to detect any candidate anchor UEs in its vicinity. This discovery procedure may entirely rely on the legacy sidelink PC5 discovery procedure (e.g., as described in TS 23.287 and TS 23.304), which is handled above the AS layer. In some aspects, both Model A and Model B discovery can be applicable in this case. As an alternative, the PC5 discovery procedure may be enhanced to include specific information within the discovery message that may aid the support of sidelink positioning. In some aspects, one or more of the following may be considered during the selection process:
(a) SL positioning capabilities, including supported positioning methods by the anchor UE;
(b) Ability to compute location information based on SL-PRS measurements; and
(c) Ability to perform absolute vs relative positioning/ranging calculation.

For the case of model A, the target UE may broadcast the discovery announcement message, which may include the SL positioning/ranging service code and the above information, which implies its interest in finding a suitable anchor UE. An anchor UE that supports the positioning method(s) and other information indicated by the target UE may respond by setting up a direct PC5 connection with the target UE to aid in the positioning session.

In the case of model B, the anchor UEs that have been authorized and provisioned by the network to act as the anchor UE for sidelink positioning may periodically broadcast a solicitation message, which can include the service code for SL positioning/ranging as well as the above information, i.e., supported positioning methods, ability to perform location estimate, etc. The target UE, which is interested in SL positioning, can then respond to the discovery message and set up a PC5 connection with the anchor UE.

An alternative approach relies on an AS layer mechanism to enable the target UE to perform the selection of suitable candidate anchor UE(s) for sidelink positioning. After the location request is triggered, the target UE determines the set of available candidate anchor UEs in the vicinity. This can be handled by using the existing PC5 discovery procedure. Once the target UE compiles the list of candidate anchor UEs, different options may be considered as detailed below, with corresponding signaling flows:
(a) Option 1: The target UE may provide this list to the LMF and/or the positioning server UE together with the information discussed above, e.g., anchor UE ID, the supported positioning methods, the location calculation capability, and the quality of the signal from the anchor UE, etc. Based on this information, the LMF and/or server UE may perform the selection of the suitable anchor UE or UEs for the target UE for further selection.
(b) Option 2: Based on the target UE location and/or service request (e.g., quality of service, requested positioning method, etc.), the LMF/server UE may perform selection of the suitable anchor UE or UEs for the target UE for further selection based on preconfigured anchor UE lists (i.e., without target UE explicitly providing a list of candidate anchor UEs beforehand, in contrast with Option 1). To enable this, the anchor UEs may directly provide their capability and other pertinent information to the LMF for pre-configuration.

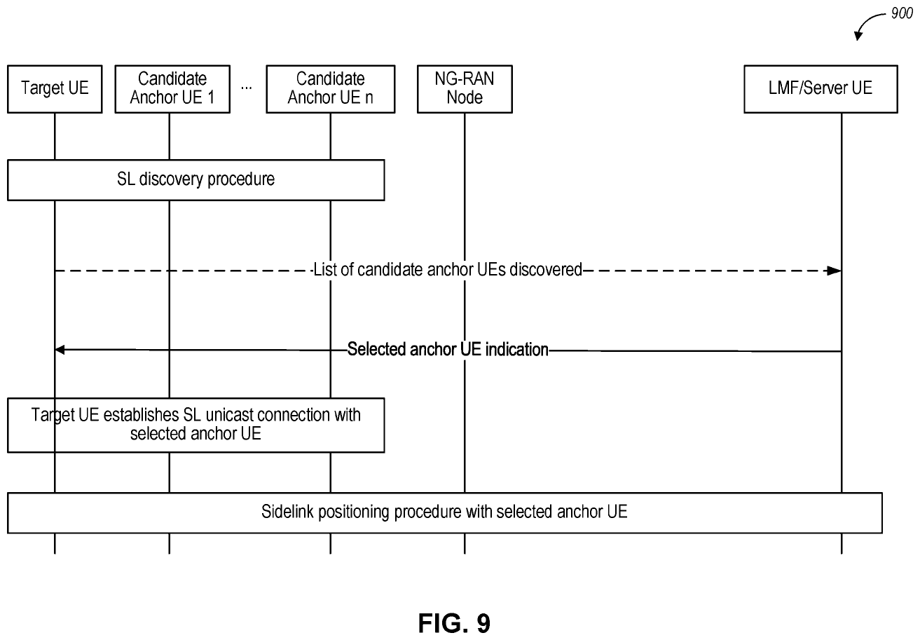

In some aspects, the LMF or server UE may select the anchor UE or anchor UEs based on, e.g., the criteria discussed above (e.g., target UE location, server request (e.g., quality of service, requested positioning method), supported positioning methods, location calculation capability, the quality of the signal from the anchor UE, authorization information, etc.). In some aspects, the selection of the anchor UE may be specified or left to LMF/server UE implementation. In some aspects, the target UE then initiates the PC5 connection setup with the selected anchor UE for sidelink positioning. In some aspects, the LMF may be able to provide this information for the case when the target UE is under direct network coverage. FIG. 9 below details the general procedure. FIG. 9 is a swimlane diagram 900 illustrating example functionalities for location management function (LMF)-based anchor UE selection, in accordance with some aspects.

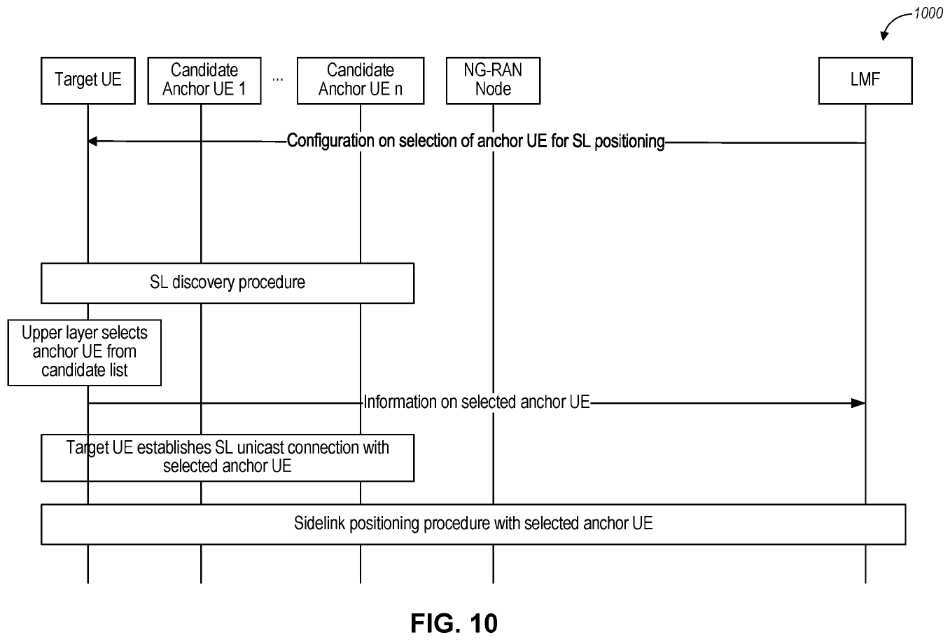

In some aspects, the UE may perform further anchor UE selection based on information provided by LMF/server UE. In some aspects, to obtain the candidate anchor UE's capability, e.g., supported positioning methods, location calculation capability, etc., the target UE may need to perform SL positioning capability exchange or otherwise obtain this based on the discovery procedure.
(c) Option 3: Based on the above options, the LMF/server UE may provide a list of candidate anchor UEs to the target UE. If so, the target UE can select the anchor UE within the list. The target UE may be configured (or preconfigured in case of OOC) by the LMF with selection criteria to use for the selection of anchor UE from the discovered candidate anchor UEs (e.g., the quality of the signal from the anchor UE, supported positioning methods, calculation capability, etc.). Based on this configuration, the target UE may compile and provide this list to the upper layer and rely on the upper layer to decide which anchor UE is selected. Alternatively, this selection may be handled at the AS layer based on the criteria specified above. Or the AS layer may check AS layer criteria (e.g., the quality of the signal from the anchor UE) and send the results to the upper layer for the final decision. In either case, upon selection, the PC5 connection to the selected anchor UE is triggered by the upper layer. This option can be applicable for both in coverage and out of coverage scenario. The signaling flow for this option is detailed in FIG. 10, which is a swimlane diagram illustrating example functionalities for LMF-assisted anchor UE selection in accordance with some aspects.

In some aspects, to obtain the candidate anchor UE's capability, e.g., supported positioning methods and location calculation capability, the target UE may need to perform SL positioning capability exchange or obtain this based on discovery procedure or get it from LMF/server UE directly.

One aspect to consider that may be applicable to the approaches discussed above is the number of anchor UEs selected. In some aspects, there may be two different kinds of selected anchor UEs selected by LMF or server UE to serve the target UE:
(a) a primary anchor UE, being mandatory or essential for the positioning session; and
(b) a secondary anchor UE, which can be optionally configured/selected for the positioning session.

In some aspects, multiple secondary anchor UEs may be configured for a target UE, and the LMF may include the primary/secondary designation indication for each selected anchor UE when sending them to the target UE. This configuration can offer support for specific QoS requirements from an application layer perspective, which may require the transmission of reference signals from multiple anchor UEs. In addition, it offers additional redundancy in case there is a link failure or some issue is encountered with the secondary anchor UEs since the positioning session can still proceed if allowed, albeit with a lower quality of service.

In some aspects, the LMF may consider the number of anchor UEs selected for the target UE based on the quality of service. For example, at least 3 anchor UEs may be involved in positioning; otherwise, the positioning result may not satisfy the application's requirements. Therefore, if the anchor UE can only discover/connect with 2 anchor UEs, then the positioning session may not continue, and error can be reported to the upper layers. Based on this, the minimum number of anchor UEs needed may be included as part of the information/configuration message sent from LMF to Target UE or defined as a requirement.

Considering the session-based approach, once the positioning session is established and the anchor UE is selected, the target UE may exchange SL positioning capability and assistance data with the anchor UE or anchor UEs. Different from the Uu case, both the target UE and the anchor UE/anchor UEs may be mobile during this process, and it is a distinct possibility that the link quality between them may be constantly changing. Since that directly translates to the quality of service for the positioning method being used, the continued availability of anchor UE during the entire positioning session poses a unique issue. For instance, if the anchor UE and target UE move further apart or experience NLOS, the SL-PRS measurements may become highly imprecise, leading to the quality of service requirement for the chosen positioning method no longer being met. As described above, if only one anchor UE is involved, then failure will happen. If multiple anchor UEs are involved, and the number of available anchors cannot meet the performance requirement, failure will happen. When the issue occurs, a solution from legacy positioning design, in this case, would be to report failure to the location server and retrigger the session again. However, in such a scenario, it may be helpful to allow the target UE to search for and select another suitable anchor UE to either continue the positioning session or abandon and begin a new session.

In some aspects, the target UE may provide information about the ongoing positioning session with the anchor UE to the upper layer, with the goal of determining if there is a need to reselect to another anchor UE. The trigger on when this information is provided to the upper layer can be based on different factors, such as:
(a) If there exists a unicast link between the target UE and the anchor UE, the SL link quality (e.g., based on SL-RSRP) can be used to determine whether the anchor UE is considered valid.
(b) The anchor UE can provide an indication to the target UE based on its criteria, e.g., in case it has to perform power saving and cannot continue with SL-PRS transmission or location estimation.
(c) Anchor UE can redirect the target UE to reselect to another candidate anchor UE by sending an indication (e.g., based on implementation).
(d) Anchor UE can provide a bit indication on whether it can still support the required quality of service for SL positioning method/session.
(e) Anchor UE can indicate that it cannot be able to continue transmission of SL-PRS because, e.g., it has to perform power saving or other reasons.

In some aspects, the target UE may be configured with criteria to trigger anchor UE selection from among the ones captured above. The LMF or server UE may provide such configuration to the target UE (either in coverage or out of coverage via pre-configuration). Upon meeting the condition, the target UE may send an indication to the upper layer to either terminate the ongoing positioning session to start anew or modify by discovering a new anchor UE, using the procedure described in the previous section).

In some aspects, when discovering and evaluating candidate anchor UEs, once the above reselection process is triggered, there can be different ways to evaluate them. In some aspects, the link quality criteria that are specified for the case of relay reselection can be used, i.e., based on SD-RSRP or SL-RSRP (in case a unicast connection is already established with the candidate anchor UE). In some embodiments, the selection can be based on the supported positioning methods (as part of the discovery procedure specified in the earlier section) to compile a list of suitable candidate UE, and then the new anchor UE is chosen from the list based on the link quality criteria. The upper layer may provide this list of candidate anchor UEs to the AS layer for final selection, or it may select the suitable anchor UE from the list based on reported information from the AS layer.

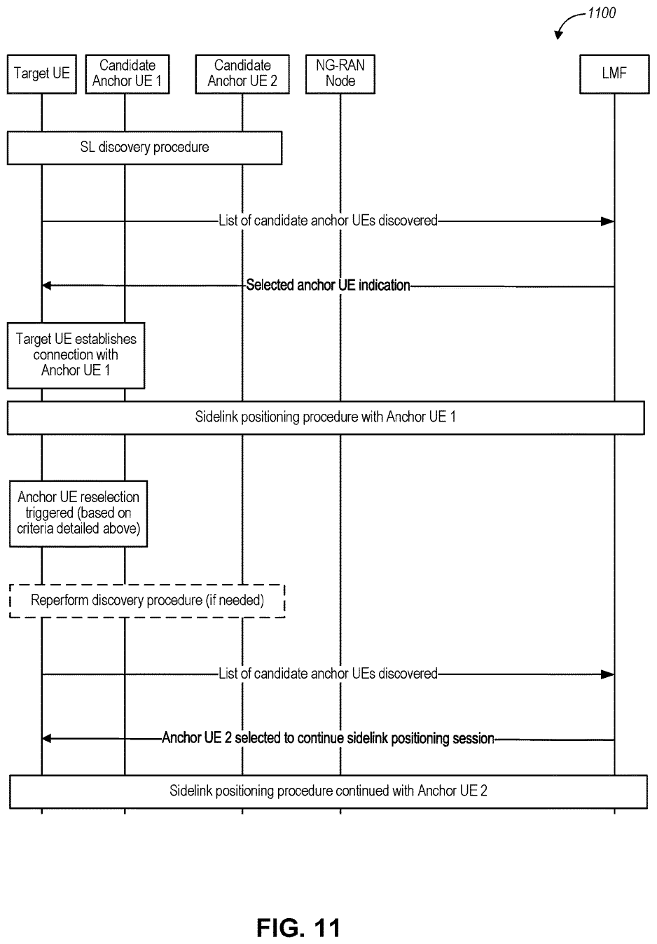

FIG. 11 is a swimlane diagram 1100 illustrating example functionalities for configuring an ongoing SL positioning session after anchor UE reselection, in accordance with some aspects. FIG. 11 shows the signaling flow for the case when the UE has an ongoing SL positioning session and needs to reselect to a new anchor UE and continue the ongoing positioning session. In some aspects, the trigger for reselection can be based on those described in the above section and may originate from the upper layer at the target UE or by the anchor UE itself. For the case of in-coverage LMF-based positioning, the LMF may also trigger the target UE to perform anchor UE reselection,

While the above discussion is mainly related to a session-based positioning operation, i.e., it assumes that a dedicated SLPP session is established among all the involved nodes/UEs before sidelink positioning is performed, a sessionless form of operation may also be supported where UEs may be able to perform SL based positioning in a best-effort manner without the need for explicit signaling to establish a session. This translates to use cases where devices may be moving in and out of communication range, and the signaling overhead associated with session modification may be too much.

In the case of session-based operation, there is additional signaling associated with modification of the SLPP session whereby the selected anchor UE is added as part of the session, and the previously selected anchor UE may be removed from the session.

In the case of a sessionless approach, the anchor UE discovery and reselection, as described above, can also work well. The discovery, evaluation, and selection of candidate anchor UEs are not impacted directly by the presence or absence of an SLPP session so that they can be applicable to session-less operations as well.

In some aspects, a system to allow discovery and selection/reselection of anchor UEs/nodes for sideline-based positioning/ranging is disclosed. In some aspects, the discovery of candidate anchor UEs to initiate the sidelink positioning procedure can performed using two distinct approaches. In some aspects, the disclosed configurations can rely on the legacy sidelink PC5 discovery procedure (both model A and B), with sidelink positioning specific information incorporated within the discovery messages, including one or more of SL positioning capabilities (including supported positioning methods by the anchor UE), the ability to compute location information based on SL-PRS measurements, and the ability to perform absolute versus relative positioning/ranging calculation.

In some aspects, the access stratum (AS) layer may perform detection of candidate anchor UEs using either LMF-based or LMF-assisted methods (and associated signaling). In some aspects, the target UE may provide a list of candidate UEs to LMF and rely on LMF to perform the selection. In some aspects, the LMF may perform the selection of anchor UE by itself without relying on information received from the target UE. In some aspects, the target UE may provide a list of candidate UEs to LMF and perform selection itself based on criteria configured by the LMF.

In some aspects, the anchor UEs may be categorized into primary and secondary anchor UEs to support diverse quality of service requirements and offer additional redundancy during the sidelink positioning procedure.

In some aspects, the anchor UE(s) may be reselected during an ongoing sidelink positioning session based on various specified triggers.

In some aspects, the target UE may be configured with criteria to trigger anchor UE reselection. Upon triggering, the target UE may send an indication to the upper layer to either terminate the ongoing positioning session to start anew or modify by discovering a new anchor UE.

In some aspects, the evaluation of candidate anchor UEs for reselection may be based on link quality criteria (as in the case of relay reselection). Alternatively, the supported positioning methods can be used to classify and rank the candidate anchor UEs.

In some aspects, the above claims for anchor UE discovery and reselection are applicable for both session-based and sessionless positioning operations, as well as for sidelink-based sensing.

In some aspects, the overall signaling flow for the sidelink positioning session is detailed in case anchor UE reselection is triggered.

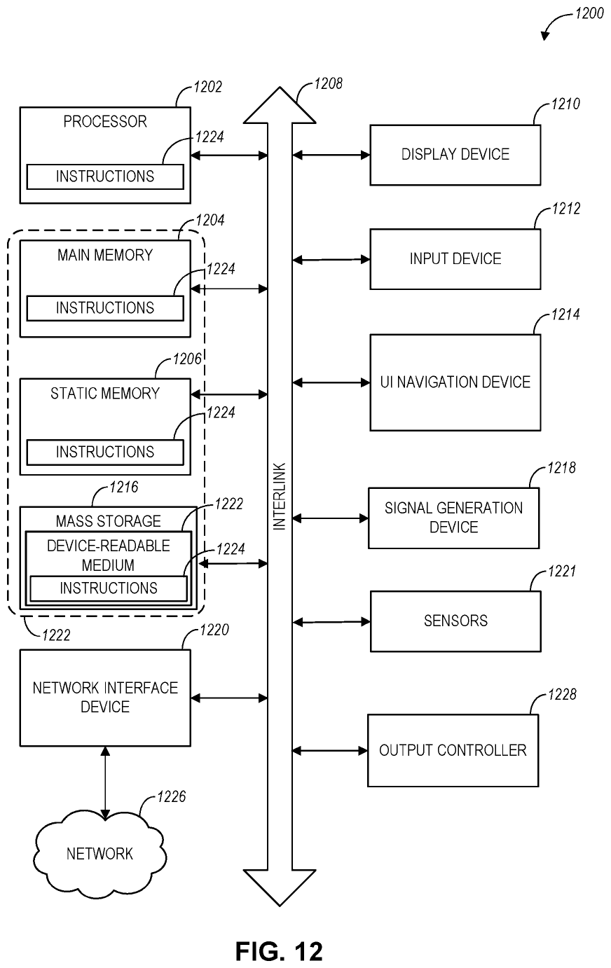

FIG. 12 illustrates a block diagram of a communication device such as an evolved Node-B (eNB), a new generation Node-B (gNB) (or another RAN node such as a base station), a network-controlled repeater (NCR), an access point (AP), a wireless station (STA), a mobile station (MS), or user equipment (UE), in accordance with some aspects and to perform one or more of the techniques disclosed herein. In alternative aspects, the communication device 1200 may operate as a standalone device or may be connected (e.g., networked) to other communication devices.

Circuitry (e.g., processing circuitry) is a collection of circuits implemented in tangible entities of the device 1200 that include hardware (e.g., simple circuits, gates, logic, etc.). Circuitry membership may be flexible over time. Circuitries include members that may, alone or in combination, perform specified operations when operating. For example, the circuitry hardware may be immutably designed to carry out a specific operation (e.g., hardwired). For example, the hardware of the circuitry may include variably connected physical components (e.g., execution units, transistors, simple circuits, etc.), including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. For example, any of the physical components may be used in more than one member of more than one circuitry. For example, under operation, execution units may be used in the first circuit of a first circuitry at one point in time and reused by a second circuit in the first circuitry, or by a third circuit in a second circuitry at a different time. Additional examples of these components with respect to the device 1200 follow.

In some aspects, the device 1200 may operate as a standalone device or may be connected (e.g., networked) to other devices. In a networked deployment, the communication device 1200 may operate in the capacity of a server communication device, a client communication device, or both in server-client network environments. For example, the communication device 1200 may act as a peer communication device in a peer-to-peer (P2P) (or other distributed) network environment. The communication device 1200 may be a UE, eNB, PC, a tablet PC, STB, PDA, mobile telephone, smartphone, a web appliance, network router, a switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules needs not to be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 1200 may include a hardware processor 1202 (e.g., a central processing unit (CPU), a graphics processing unit (GPU), a hardware processor core, or any combination thereof), a main memory 1204, a static memory 1206, and a storage device 1216 (e.g., hard drive, tape drive, flash storage, or other block or storage devices), some or all of which may communicate with each other via an interlink 1208 (e.g., a bus).

The communication device 1200 may further include a display device 1210, an input device 1212 (e.g., a keyboard), and a user interface (UI) navigation device 1214 (e.g., a mouse). In an example, the display device 1210, input device 1212, and UI navigation device 1214 may be a touchscreen display. The communication device 1200 may additionally include a signal generation device 1218 (e.g., a speaker), a network interface device 1220, and one or more sensors 1221, such as a global positioning system (GPS) sensor, compass, accelerometer, or another sensor. The communication device 1200 may include an output controller 1228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1216 may include a device-readable medium 1222, on which is stored one or more sets of data structures or instructions 1224 (e.g., software) embodying or utilized by any one or more of the techniques or functions described herein. In some aspects, registers of the hardware processor 1202, the main memory 1204, the static memory 1206, and/or the storage device 1216 may be, or include (entirely or at least partially), the device-readable medium 1222, on which is stored the one or more sets of data structures or instructions 1224, embodying or utilized by any one or more of the techniques or functions described herein. In an example, one or any combination of the hardware processor 1202, the main memory 1204, the static memory 1206, or the storage device 1216 may constitute the device-readable medium 1222.

As used herein, the term “device-readable medium” is interchangeable with “computer-readable medium” or “machine-readable medium”. While the device-readable medium 1222 is illustrated as a single medium, the term “communication device-readable medium” may include a single medium or multiple media (e.g., a centralized or distributed database and/or associated caches and servers) configured to store the instructions 1224. The term “communication device-readable medium” is inclusive of the terms “machine-readable medium” or “computer-readable medium” and may include any medium that is capable of storing, encoding, or carrying instructions (e.g., instructions 1224) for execution by the communication device 1200 and that causes the communication device 1200 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

Instructions 1224 may further be transmitted or received over a communications network 1226 using a transmission medium via the network interface device 1220 utilizing any one of several transfer protocols. In an example, the network interface device 1220 may include one or more physical jacks (e.g., Ethernet, coaxial, or phone jacks) or one or more antennas to connect to the communications network 1226. In an example, the network interface device 1220 may include a plurality of antennas to wirelessly communicate using at least one of the single-input-multiple-output (SIMO), MIMO, or multiple-input-single-output (MISO) techniques. In some examples, the network interface device 1220 may wirelessly communicate using Multiple User MIMO techniques.

The term “transmission medium” shall be taken to include any intangible medium that is capable of storing, encoding, or carrying instructions for execution by the communication device 1200 and includes digital or analog communications signals or another intangible medium to facilitate communication of such software. In this regard, a transmission medium in the context of this disclosure is a device-readable medium.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Described implementations of the subject matter can include one or more features, alone or in combination, as illustrated below by way of examples.

Example 1 is an apparatus for a user equipment (UE) configured for operation as a target UE in a Fifth Generation New Radio (5G NR) network, the apparatus comprising: processing circuitry, wherein to configure the UE for sidelink-based positioning in the 5G NR network, the processing circuitry is to: encode a discovery announcement message for broadcasting to a plurality of anchor UEs, the discovery announcement message including a sidelink positioning service code and sidelink positioning capabilities of the target UE; decode a discovery response message received from an anchor UE of the plurality of anchor UEs via a direct PC5 communication link established by the anchor UE, the discovery response message indicating sidelink positioning capabilities of the anchor UE; and initiate a positioning session with the anchor UE based on the sidelink positioning capabilities of the anchor UE matching the sidelink positioning capabilities of the target UE; and a memory coupled to the processing circuitry and configured to store the discovery response message.

In Example 2, the subject matter of Example 1 includes subject matter where the processing circuitry is to encode the discovery announcement message to further indicate the capability of the target UE to compute location information based on sidelink positioning reference signal (SL-PRS) measurements.

In Example 3, the subject matter of Example 2 includes subject matter where the processing circuitry is to initiate the positioning session based on the discovery response message indicating a capability of the anchor UE, which matches the capability of the target UE to compute the location information.

In Example 4, the subject matter of Examples 1-3 includes subject matter where the processing circuitry is to encode the discovery announcement message to further indicate the capability of the target UE to perform absolute positioning calculations or relative positioning calculations based on sidelink positioning reference signal (SL-PRS) measurements.

In Example 5, the subject matter of Example 4 includes subject matter where the processing circuitry is to initiate the positioning session based on the discovery response message indicating a capability of the anchor UE which matches the capability of the target UE to perform the absolute positioning calculations or the relative positioning calculations.

In Example 6, the subject matter of Examples 1-5 includes subject matter where the processing circuitry is to determine a set of anchor UEs from the plurality of anchor UEs based on the discovery announcement message, the set of anchor UEs being available for the positioning session with the target UE.

In Example 7, the subject matter of Example 6 includes subject matter where the processing circuitry is to encode a list with the set of anchor UEs and the sidelink positioning capabilities of the target UE for transmission to a location management function (LMF) server of the 5G NR network.

In Example 8, the subject matter of Example 7 includes subject matter where the processing circuitry is to decode a response message from the LMF server, the response message indicating at least a second anchor UE from the set of anchor UEs, the response message based on the sidelink positioning capabilities of the target UE; and initiate a second positioning session with the at least second anchor UE.

In Example 9, the subject matter of Example 8 includes subject matter where the response message is further based on a capability of the target UE to compute location information based on sidelink positioning reference signal (SL-PRS) measurements.

In Example 10, the subject matter of Examples 1-9 includes transceiver circuitry coupled to the processing circuitry; and two or more antennas coupled to the transceiver circuitry.

Example 11 is a computer-readable storage medium that stores instructions for execution by one or more processors of a location management function (LMF) node, the instructions to configure the LMF node for sidelink-based positioning in a Fifth Generation New Radio (5G NR) and beyond network, and to cause the LMF node to perform operations comprising: decoding a reception from a target user equipment (UE), the reception including a list with a set of anchor UEs and sidelink positioning capabilities of the target UE; and encoding a response message for transmission to the target UE, the response message indicating at least one anchor UE from the set of anchor UEs for establishing a positioning session with the target UE.

In Example 12, the subject matter of Example 11 includes subject matter where the response message is further based on a capability of the target UE to compute location information based on sidelink positioning reference signal (SL-PRS) measurements.

Example 13 is a computer-readable storage medium that stores instructions for execution by one or more processors of a user equipment (UE), the instructions to configure the UE as a target UE for sidelink-based positioning in a Fifth Generation New Radio (5G NR) and beyond network, and to cause the UE to perform operations comprising: encoding a discovery announcement message for broadcasting to a plurality of anchor UEs, the discovery announcement message including a sidelink positioning service code and sidelink positioning capabilities of the target UE; decoding a discovery response message received from an anchor UE of the plurality of anchor UEs via a direct PC5 communication link established by the anchor UE, the discovery response message indicating sidelink positioning capabilities of the anchor UE; and initiating a positioning session with the anchor UE based on the sidelink positioning capabilities of the anchor UE matching the sidelink positioning capabilities of the target UE.

In Example 14, the subject matter of Example 13 includes the operations further comprising encoding the discovery announcement message to further indicate the capability of the target UE to compute location information based on sidelink positioning reference signal (SL-PRS) measurements.

In Example 15, the subject matter of Example 14 includes the operations further comprising initiating the positioning session based on the discovery response message indicating a capability of the anchor UE, which matches the capability of the target UE to compute the location information.

In Example 16, the subject matter of Examples 13-15 includes the operations further comprising encoding the discovery announcement message to further indicate a capability of the target UE to perform absolute positioning calculations or relative positioning calculations based on sidelink positioning reference signal (SL-PRS) measurements.

In Example 17, the subject matter of Example 16 includes the operations further comprising initiating the positioning session based on the discovery response message indicating a capability of the anchor UE, which matches the capability of the target UE to perform the absolute positioning calculations or the relative positioning calculations.

In Example 18, the subject matter of Examples 13-17 includes the operations further comprising: determining a set of anchor UEs from the plurality of anchor UEs based on the discovery announcement message, the set of anchor UEs being available for the positioning session with the target UE.

In Example 19, the subject matter of Example 18 includes the operations further comprising encoding a list with the set of anchor UEs and the sidelink positioning capabilities of the target UE for transmission to a location management function (LMF) server of the 5G NR network.

In Example 20, the subject matter of Example 19 includes the operations further comprising: decoding a response message from the LMF server, the response message indicating at least a second anchor UE from the set of anchor UEs, the response message based on the sidelink positioning capabilities of the target UE; and initiating a second positioning session with the at least second anchor UE.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

Although an aspect has been described concerning specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

1-20. (canceled)

21. An apparatus for a user equipment (UE) configured for operation as a target UE in a Fifth Generation New Radio (5G NR) network, the apparatus comprising:
processing circuitry, wherein to configure the UE for sidelink-based positioning in the 5G NR network, the processing circuitry is to:
encode a discovery announcement message for broadcasting to a plurality of anchor UEs, the discovery announcement message including a sidelink positioning service code and sidelink positioning capabilities of the target UE;
decode a discovery response message received from an anchor UE of the plurality of anchor UEs via a direct PC5 communication link established by the anchor UE, the discovery response message indicating sidelink positioning capabilities of the anchor UE; and
initiate a positioning session with the anchor UE based on the sidelink positioning capabilities of the anchor UE matching the sidelink positioning capabilities of the target UE; and
a memory coupled to the processing circuitry and configured to store the discovery response message.

22. The apparatus of claim 21, wherein the processing circuitry is to:
encode the discovery announcement message to further indicate a capability of the target UE to compute location information based on sidelink positioning reference signal (SL-PRS) measurements.

23. The apparatus of claim 22, wherein the processing circuitry is to:
initiate the positioning session based on the discovery response message indicating a capability of the anchor UE which matches the capability of the target UE to compute the location information.

24. The apparatus of claim 21, wherein the processing circuitry is to:
encode the discovery announcement message to further indicate a capability of the target UE to perform absolute positioning calculations or relative positioning calculations based on sidelink positioning reference signal (SL-PRS) measurements.

25. The apparatus of claim 24, wherein the processing circuitry is to:
initiate the positioning session based on the discovery response message indicating a capability of the anchor UE which matches the capability of the target UE to perform the absolute positioning calculations or the relative positioning calculations.

26. The apparatus of claim 21, wherein the processing circuitry is to:
determine a set of anchor UEs from the plurality of anchor UEs based on the discovery announcement message, the set of anchor UEs being available for the positioning session with the target UE.

27. The apparatus of claim 26, wherein the processing circuitry is to:
encode a list with the set of anchor UEs and the sidelink positioning capabilities of the target UE for transmission to a location management function (LMF) server of the 5G NR network.

28. The apparatus of claim 27, wherein the processing circuitry is to:
decode a response message from the LMF server, the response message indicating at least a second anchor UE from the set of anchor UEs, the response message based on the sidelink positioning capabilities of the target UE; and
initiate a second positioning session with the at least second anchor UE.

29. The apparatus of claim 28, wherein the response message is further based on a capability of the target UE to compute location information based on sidelink positioning reference signal (SL-PRS) measurements.

30. The apparatus of claim 1, further comprising:
transceiver circuitry coupled to the processing circuitry; and
two or more antennas coupled to the transceiver circuitry.

31. A non-transitory computer-readable storage medium that stores instructions for execution by one or more processors of a location management function (LMF) node, the instructions to configure the LMF node for sidelink-based positioning in a Fifth Generation New Radio (5G NR) and beyond network, and to cause the LMF node to perform operations comprising:
decoding a reception from a target user equipment (UE), the reception including a list with a set of anchor UEs and sidelink positioning capabilities of the target UE; and
encoding a response message for transmission to the target UE, the response message indicating at least one anchor UE from the set of anchor UEs for establishing a positioning session with the target UE.

32. The non-transitory computer-readable storage medium of claim 31, wherein the response message is further based on a capability of the target UE to compute location information based on sidelink positioning reference signal (SL-PRS) measurements.

33. A non-transitory computer-readable storage medium that stores instructions for execution by one or more processors of a user equipment (UE), the instructions to configure the UE as a target UE for sidelink-based positioning in a Fifth Generation New Radio (5G NR) and beyond network, and to cause the UE to perform operations comprising:
encoding a discovery announcement message for broadcasting to a plurality of anchor UEs, the discovery announcement message including a sidelink positioning service code and sidelink positioning capabilities of the target UE;
decoding a discovery response message received from an anchor UE of the plurality of anchor UEs via a direct PC5 communication link established by the anchor UE, the discovery response message indicating sidelink positioning capabilities of the anchor UE; and
initiating a positioning session with the anchor UE based on the sidelink positioning capabilities of the anchor UE matching the sidelink positioning capabilities of the target UE.

34. The non-transitory computer-readable storage medium of claim 33, the operations further comprising:
encoding the discovery announcement message to further indicate a capability of the target UE to compute location information based on sidelink positioning reference signal (SL-PRS) measurements.

35. The non-transitory computer-readable storage medium of claim 34, the operations further comprising:
initiating the positioning session based on the discovery response message indicating a capability of the anchor UE that matches the capability of the target UE to compute the location information.

36. The non-transitory computer-readable storage medium of claim 33, the operations further comprising:
encoding the discovery announcement message to further indicate a capability of the target UE to perform absolute positioning calculations or relative positioning calculations based on sidelink positioning reference signal (SL-PRS) measurements.

37. The non-transitory computer-readable storage medium of claim 36, the operations further comprising:
initiating the positioning session based on the discovery response message indicating a capability of the anchor UE that matches the capability of the target UE to perform the absolute positioning calculations or the relative positioning calculations.

38. The non-transitory computer-readable storage medium of claim 33, the operations further comprising: determining a set of anchor UEs from the plurality of anchor UEs based on the discovery announcement message, the set of anchor UEs being available for the positioning session with the target UE.

39. The non-transitory computer-readable storage medium of claim 38, the operations further comprising:
encoding a list with the set of anchor UEs and the sidelink positioning capabilities of the target UE for transmission to a location management function (LMF) server of the 5G NR network.

40. The non-transitory computer-readable storage medium of claim 39, the operations further comprising:
decoding a response message from the LMF server, the response message indicating at least a second anchor UE from the set of anchor UEs, the response message based on the sidelink positioning capabilities of the target UE; and
initiating a second positioning session with the at least second anchor UE.
